(19) United States
(12) Patent Application Publication
(10) Pub. No.: US 2013/0304534 A1
(43) Pub. Date: Nov. 14, 2013

(54) Wait Time Notification System

(71) Applicants: Manish K. Mehta, Chicago, IL (US); Vishal Mehta, Naperville, IL (US); Syed Akhter, Chicago, IL (US)

(72) Inventors: Manish K. Mehta, Chicago, IL (US); Vishal Mehta, Naperville, IL (US); Syed Akhter, Chicago, IL (US)

(21) Appl. No.: 13/668,247

(22) Filed: Nov. 3, 2012

Related U.S. Application Data
(63) Continuation of application No. PCT/US2011/035284, filed on May 5, 2011.

(51) Int. Cl. G06Q 10/10

(52) U.S. Cl. CPC G06Q 10/1095
USPC 705/7.19

(57) ABSTRACT

A system and method for determining the wait information for a service provider and notifying a user about the wait information. The system provides the wait information to the user in response to a request from the user. The wait information may include the wait time for the service provider or the time a user may be allowed to arrive after an appointment time for the user.

### CROSS-REFERENCE TO RELATED APPLICATIONS

This application is a continuation application of PCT/US2011/035284, titled Wait Time Notification System, filed on May 5, 2011, which claims priority to U.S. Provisional Application Ser. No. 61/395,157 filed May 5, 2010 and U.S. Provisional Application Ser. No. 61/404,026 filed Sep. 24, 2010. These foregoing applications are hereby incorporated by reference.

### BACKGROUND

Professionals typically allow individuals who are seeking services of that professional to schedule an appointment. A particular date and time for the appointment is usually provided to the individual. Professionals will schedule multiple appointments on a particular day or within a particular time frame. The appointment will typically be scheduled for a fixed duration and the professional will schedule other appointments based on the expectation that a particular appointment will not exceed the fixed duration.

The service industry, however, is unpredictable and the amount of time necessary to perform a service for or on an individual may take longer than expected and exceed the amount of time provided for in the professional's schedule. When the time of an appointment exceeds the expected amount of time, it causes the professional to run behind schedule. Thus the next appointment will not be seen by the professional at the originally schedule time. A domino effect may take place where each appointment may run longer than expected, thus increasing the amount of time the professional is running behind and the waiting time for the individual who is waiting for the professional. There is currently no good way to allow notify an individual that the professional is running behind so as to prevent or minimize the time spent waiting by the individual for the professional.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 is a diagram of a customer facing interface system;

FIG. 3 is a diagram of one aspect of the customer facing interface system;

FIG. 4 is a diagram of one aspect of the customer facing interface system;

FIG. 5 is a diagram of one aspect of the customer facing interface system;

FIG. 6 is a diagram of one aspect of the customer facing interface system;

FIG. 7 is a diagram of one aspect of the customer facing interface system;

FIG. 8 is a diagram of one aspect of the customer facing interface system;

FIG. 9 is a diagram of one aspect of the customer facing interface system;

FIG. 10 is a diagram of one aspect of the customer facing interface system;

FIG. 11 is a diagram of one aspect of the customer facing interface system;

FIG. 12 is a diagram of one aspect of the customer facing interface system;

FIG. 13 is a diagram of one aspect of the customer facing interface system;

FIG. 14 is a diagram of one aspect of the customer facing interface system;

FIG. 15 is a diagram of one aspect of the customer facing interface system;

FIG. 16 is a diagram of one aspect of the customer facing interface system;

FIG. 17 is a diagram of one aspect of the customer facing interface system;

FIG. 18 is a diagram of one aspect of the customer facing interface system;

FIG. 19 is a diagram of one aspect of the customer facing interface system;

FIG. 20 is a diagram of a user facing interface system;

FIG. 21 is a diagram of one aspect of the user facing interface system;

FIG. 22 is a diagram of one aspect of the user facing interface system;

FIG. 23 is a diagram of one aspect of the user facing interface system;

FIG. 24 is a diagram of one aspect of the user facing interface system;

FIG. 25 is a diagram of one aspect of the user facing interface system;

FIG. 26 is a diagram of one aspect of the user facing interface system;

FIG. 27 is a diagram of one aspect of the user facing interface system;

FIG. 28 is a diagram of one aspect of the user facing interface system;

FIG. 29 is a diagram of one aspect of the user facing interface system;

FIG. 30 is a diagram of one aspect of the user facing interface system;

FIG. 31 is a diagram of one aspect of the user facing interface system;

FIG. 32 is a diagram of one aspect of the user facing interface system;

FIG. 33 is a diagram of one aspect of the user facing interface system;

FIG. 34 is a diagram of one aspect of the user facing interface system;

FIG. 35 is a diagram of one aspect of the user facing interface system;

FIG. 36 is a diagram of one aspect of the user facing interface system;

FIG. 37 is a diagram of one aspect of the user facing interface system;

FIG. 38 is a diagram of one aspect of the user facing interface system; and

FIG. 39 is a diagram of one aspect of the user facing interface system.

### DETAILED DESCRIPTION OF THE DRAWINGS AND THE PRESENTLY PREFERRED EMBODIMENTS

This application is directed to a system directed to notifying individuals about wait times for services. Specifically, this system is directed to notifying individuals, including patients, about wait times at health care facilities, such as doctor offices, urgent care clinics, and hospital departments, including emergency rooms. The system is also able to notify individuals about available same-day appointments. It can be appreciated that this system may be used for other services that require an appointment or that can potentially have a wait time, such as physical therapy, chiropractic services, hair care services, gas stations, grocery stores, and the like.

The example herein is directed to a waiting time system for doctor's offices. However, this system can be easily adaptable to other services that may have a wait time. Therefore, this application is intended to cover all such services, some of which are stated above, but will be illustrated using of health care facilities as an example.

The first aspect of this system allows a patient/user to check whether his/her doctor is running on time for a scheduled appointment for that particular day prior to arriving to the facility or after the patient has arrived at the facility. The patient types in the last name of the doctor, enters the appointment time and views the current status, or the wait time information. The current status may be either: Green, Yellow, or Red and an associated way time may be posted along with the color-status and any other custom message. The patient may enter his/her email or telephone number for an automatic notification a set period from the scheduled appointment time. The patient can further view the doctor's website or other pertinent contact information.

The second aspect allows a patient to view local ER/Urgent Clinic/Hospital Department (e.g. X-ray department) wait times. The patient chooses the particular department (e.g. ER, X-ray), enters her/her address into a text box and chooses a radius within to search for a particular department. The system returns a list of the type of chosen department along with the distance from the entered address and the current wait time. The patient can select a desired department to view the department's website or other pertinent contact information.

The final aspect allows a patient to search same day appointments for a particular specialty (e.g. Dermatologist or Orthopedic surgeon). The patient chooses the desired specialty, enters his/her address, and selects a radius within to search for the specialty. The system returns a list of specialty doctors accepting walk-ins that day and the distance from the entered address. The patient may then be able to request an appointment based on the available appointments displayed by the doctor.

On the administrative side, the system allows a doctor or status updater or hospital department (collectively referred to as a “user”) to manually enter the wait time information that is retrieved by the patient. It can be appreciated that the wait time information may be automatically displayed by the system via an user facing interface. The system allows the administrator to log into the system and enter the current wait time for a particular doctor/hospital/ER, etc. The administrator enters in the color (green, yellow, red) and may enter in the minutes to arrive late and any additional information. The administrator may also check a box indicating whether a particular doctor is accepting walk-ins for that day. The administrator may handle multiple doctors/departments (if authorized) from a single account.

It is also contemplated that the system allows the doctor/hospital status to be updated automatically (via an API) and an automatic appointment notification system (ANS). The ANS allows an administrator to enter into the system an upcoming appointment for a patient and the ANS will send out a text/email to that patient the day of the appointment. The email will remind the patient of the appointment and include the wait time information discussed above.

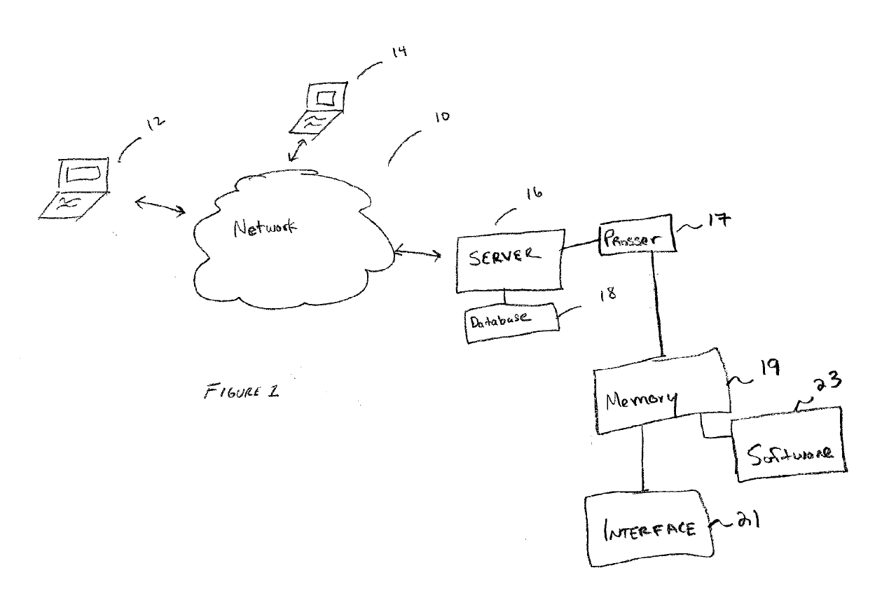

As shown in FIG. 1, the computer network 10 may be any type of computer network that may interconnect a plurality of user devices 12, 14. Of course, any number of user devices may be connected to the computer network 10 and the invention should not be construed as limited as herein described. Further, the computer network 10 may be, for example, the internet wherein a plurality of remote user devices are connected via a telephone network or other like network to each other. In addition, the computer network 10 may be an intranet wherein the plurality of user devices 12, 14 are connected via a network internal to an organization, such as a business, institution or the like. For example, the network may be connected via a LAN network. However, any computer network may be utilized that may be apparent to those skilled in the art. It can be appreciated that the information may be communicated to an individual through other means, such as a mobile application, e.g. i-phone, or any web enabled browser. Herein, the phrase “connected” is defined to mean directly coupled to or indirectly coupled through one or more intermediate components. Such intermediate components may include both hardware and software based components. Variations in the arrangement and type of the components may be made without departing from the spirit or scope of the claims as set forth herein. Additional, different or fewer components may be provided.

The user devices 12, 14 may be a computing device which allows a user to connect to a network 104, such as the Internet. Examples of a user device include, but are not limited to, a personal computer, i-pad, personal digital assistant (“PDA”), cellular phone, or other electronic device. The user device 12, 14 may be configured to allow a user to interact with the server 16 or other components of the system 20, such as the database 18. The user device 12 may include a keyboard, keypad or a cursor control device, such as a mouse, or a joystick, touch screen display, remote control or any other device operative to allow a user to interact with the system 20 via the user device 12. In one embodiment, the user device 12 is configured to request and receive information from the system 20, such as a web page that is provided by the system 29. The user device 12 may be configured to access other data/information in addition to web pages over the network 10 using a web browser, such as INTERNET EXPLORER® (sold by Microsoft Corp., Redmond, Wash.) or FIREFOX® (provided by Mozilla).

The server 16 may include the database 18 associated therewith. The database 18 may contain information relating to the wait time information and walk in availability for doctors, urgent cares, and hospital departments. A patient seeking to access the system 20 to retrieve the information from the database 18 may use a computer 12, 14 or any other computer connected via the computer network 10 to access the database 18 via a website through the computer network 10. The network 10, therefore, allows for updates and access to those updates regarding information relating to the wait time and walk in availability for doctors, urgent cares, and hospital departments.

The server 16 may include a processor 17 which may include a central processing unit (CPU), a graphics processing unit (GPU), a digital signal processor (DSP) or other type of processing device. The processor 17 may be a component in any one of a variety of systems. For example, the processor 17 may be part of a standard personal computer or a workstation. The processor 17 may be one or more general processors, digital signal processors, application specific integrated circuits, field programmable gate arrays, servers, networks, digital circuits, analog circuits, combinations thereof, or other now known or later developed devices for analyzing and processing data. The processor 17 may operate in conjunction with a software program, such as code generated manually (i.e., programmed).

The processor 17 may be coupled with a memory 19, or the memory 19 may be a separate component. The interface 21 and/or the software 23 may be stored in the memory 19. The memory 19 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 19 may include a random access memory for the processor 17. Alternatively, the memory 19 may be separate from the processor 17, such as a cache memory of a processor, the system memory, or other memory. The memory 19 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 19 is operable to store instructions executable by the processor 17.

The functions, acts or tasks illustrated in the figures or described herein may be performed by the programmed processor executing the instructions stored in the memory 19. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 17 is configured to execute the software 23. The software 23 may include instructions for analyzing and identifying a correlation.

The interface 21 may be a user input device or a display. The interface 21 may include a keyboard, keypad or a cursor control device, such as a mouse, or a joystick, touch screen display, remote control or any other device operative to interact with the system 20. The interface 21 may include a display coupled with the processor 17 and configured to display an output from the processor 17. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 17, or as an interface with the software 23 for providing input parameters.

The present disclosure contemplates a computer-readable medium that includes instructions or receives and executes instructions responsive to a propagated signal, so that a device connected to a network can communicate voice, video, audio, images or any other data over a network. The interface 21 may be used to provide the instructions over the network via a communication port. The communication port may be created in software or may be a physical connection in hardware. The communication port may be configured to connect with a network, external media, display, or any other components in system 20, or combinations thereof. The connection with the network may be a physical connection, such as a wired Ethernet connection or may be established wirelessly as discussed below. Likewise, the connections with other components of the system 20 may be physical connections or may be established wirelessly.

Any of the components in the system 20 may be coupled with one another through a network, including but not limited to the network 10. For example, the user devices 12, 14 may be coupled with the server 16 through a network. As another example, the user devices 12, 14 may be coupled with the database 18 through a network. Accordingly, any of the components in the advertising system 20 may include communication ports configured to connect with a network.

The network or networks that may connect any of the components in the system 20 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

The system 20, server 16, the database 18, and/or the user devices 12, 14 may represent computing devices of various kinds. Such computing devices may generally include any device that is configured to perform computation and that is capable of sending and receiving data communications by way of one or more wired and/or wireless communication interfaces, such as interface 21. For example, the user device 12, 14 may be configured to execute a browser application that employs HTTP to request information, such as a web page, from the server 16. The present disclosure contemplates the use of a computer-readable medium that includes instructions or receives and executes instructions responsive to a propagated signal, so that any device connected to a network can communicate voice, video, audio, images or any other data over a network.

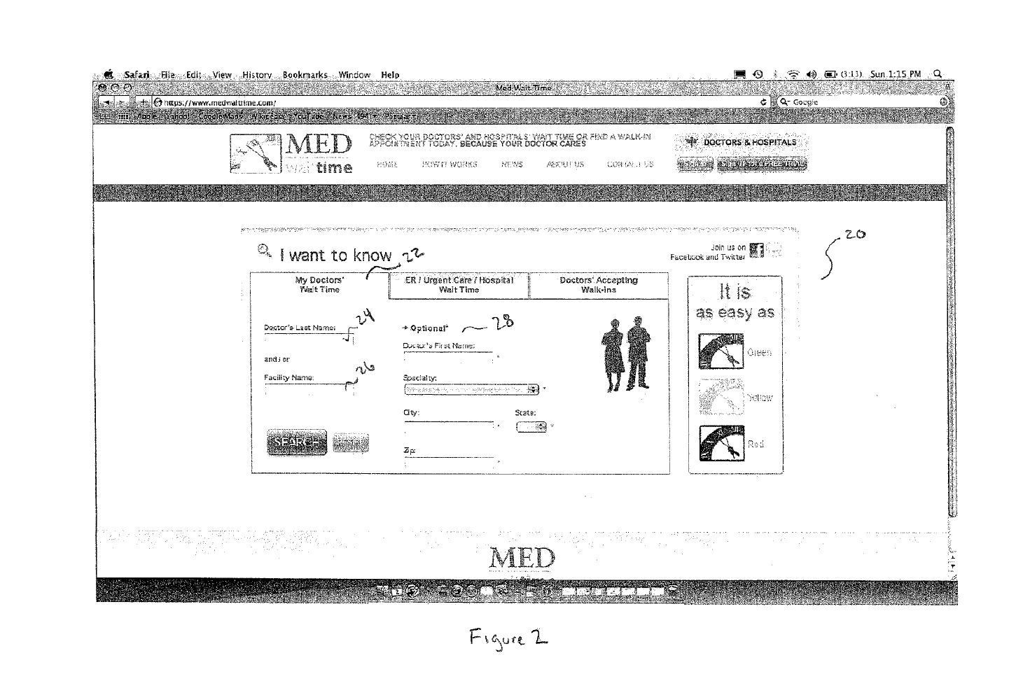

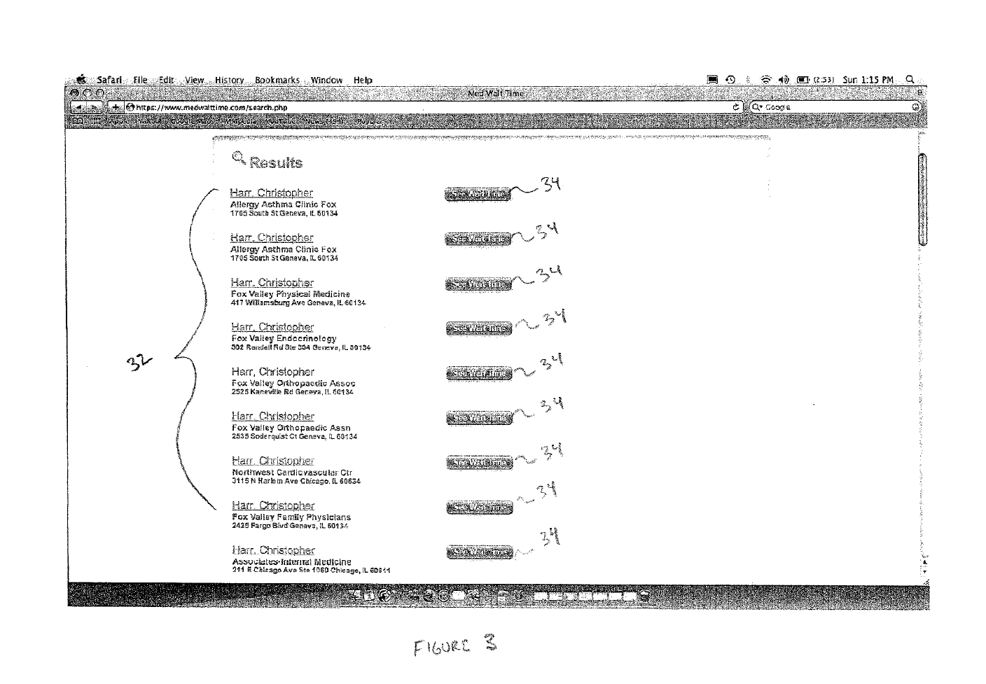

As shown in FIG. 2, the system 20, includes a patient interface 21. The patient interface 21 may communicate with the user devices 12, 14, the server 16 or database 18. In this embodiment, the system 20 is customized to provide wait times for physicians and health care facilities (including emergency departments and emergency rooms) and request an appointment for physicians and health care facilities. It is to be understood that the system 20 can be modified to display the wait times for any other types of services where a wait is involved and request an appointment for any other types of services where an appointment may be scheduled.

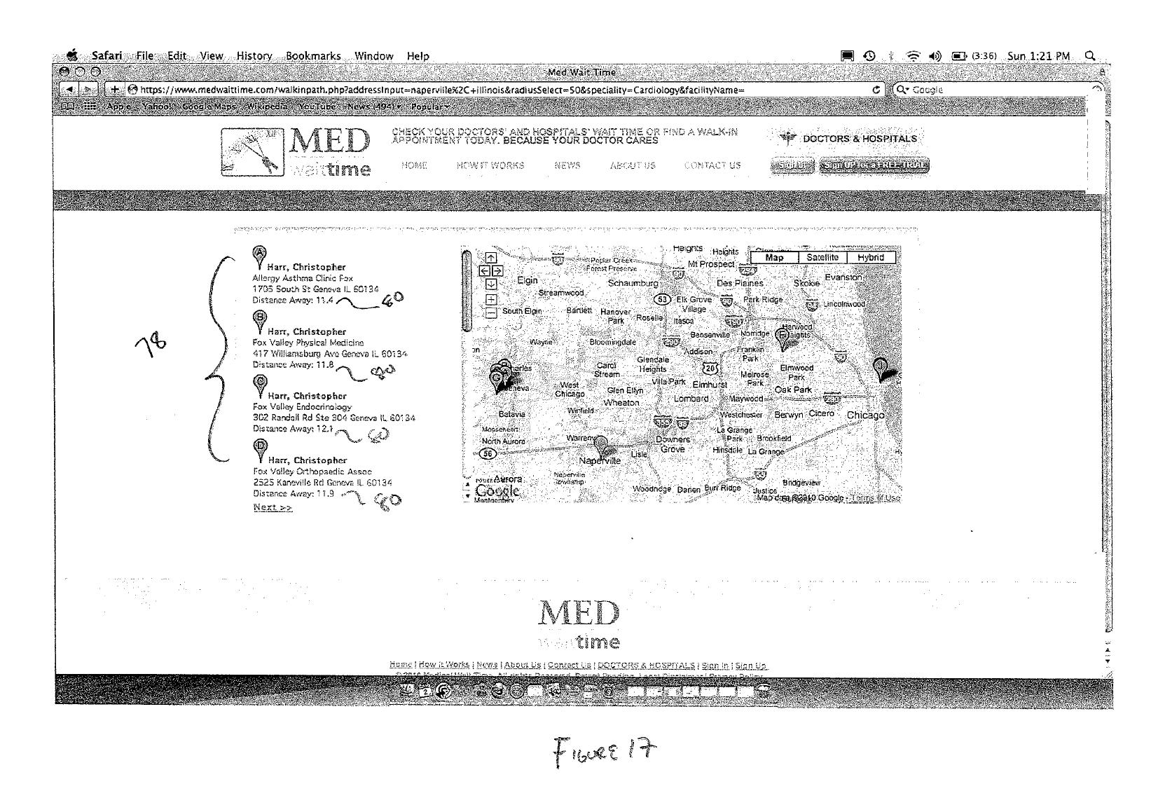

In this embodiment, the patient interface 21 enables the patient to access his/her doctor's wait time 22. The patient enters either the doctor's last name in the field 24 or the facility name in the field 26. The patient may also add additional search information located in the optional section 28, including the doctor's first name, specialty, city, state, or zip code. As shown in FIG. 19, the system 20 can retrieve a list of specialties 27 for the patient to choose from. Once the desired information is entered, the patient may select the search button 30 to retrieve the search results.

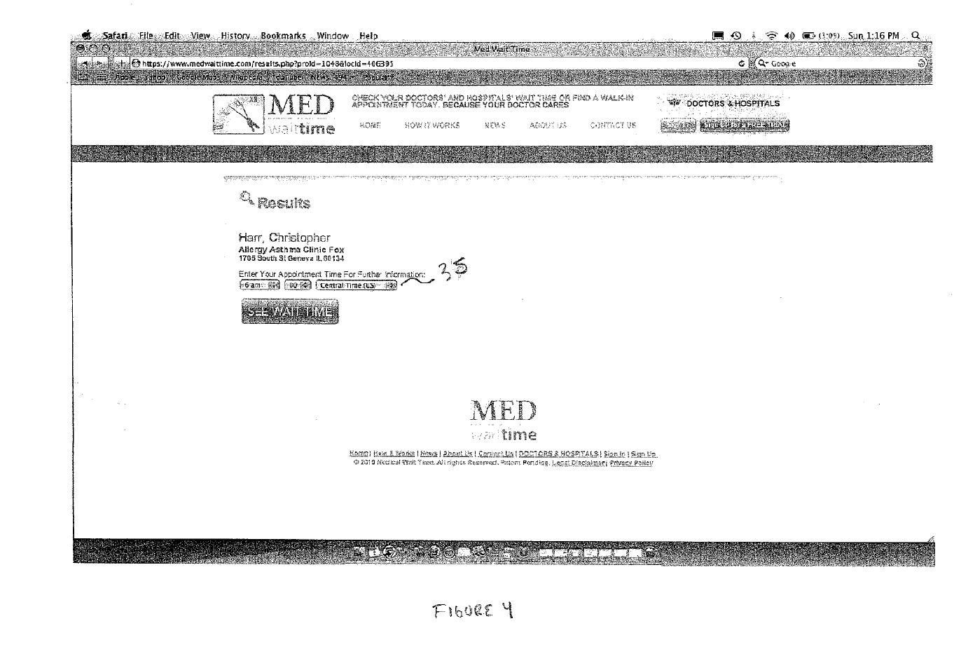

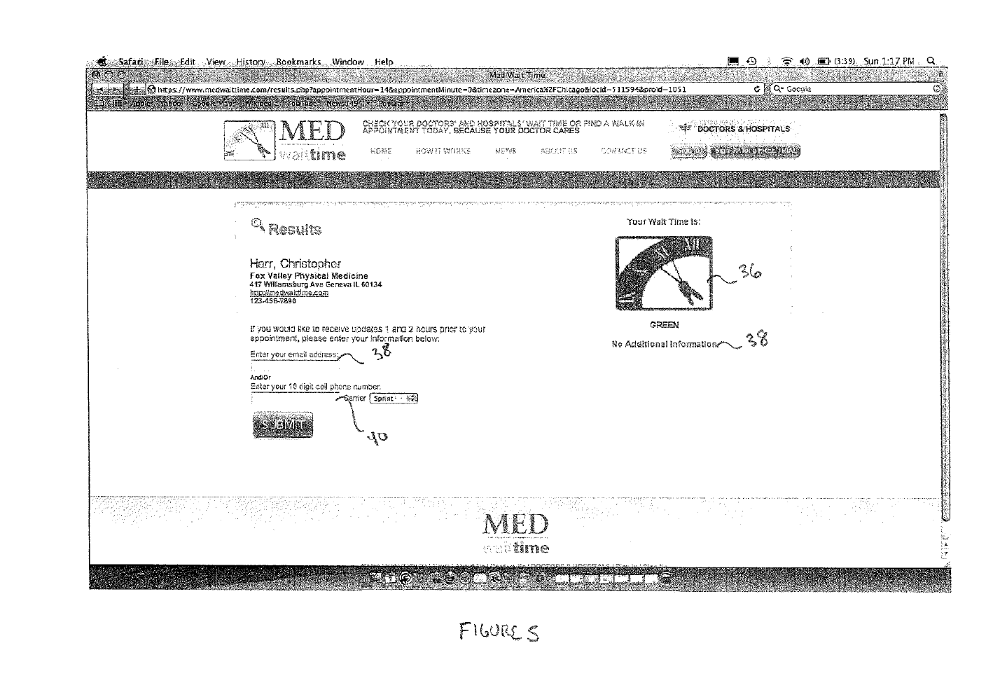

The system 20 will retrieve the subscribing doctors 32 from which the patient can select his/her doctor. The patient may then select his/her doctor by selecting button 34. FIG. 4 is the page which will appear once the patient selects his/her doctor. The patient will then enter the scheduled appointment time in the field 35 to view the wait time. FIG. 5 is the page which will return the current wait time of the doctor. In this case, the wait time indicator 36 is green. It may also be yellow, red, or state that clinic is cancelled. In addition, the doctor may enter specific information relating to the wait time in the field 38 the wait time indicator 36. Additional information may a reason why the doctor is running late or an instruction to come after the patient's scheduled appointment time. The patient may also enter his/her email 38 or telephone number 40 should the patient elect to receive updates prior to the scheduled appointment times. The update will include at leas the wait time information displayed by the system 20 should the patient log onto the system 20 within two hours of his/her scheduled appointment time.

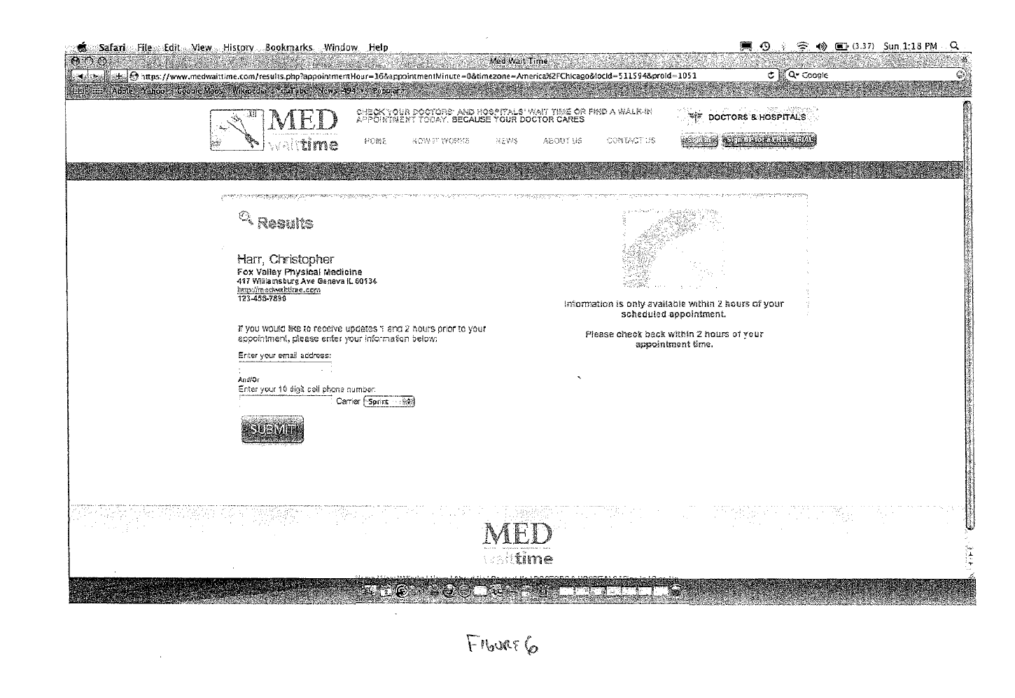

As shown in FIG. 6, if the patient enters a scheduled appointment time 35 that is greater than a set time period from the current time, such as two hours, the system 20 will not display the current wait time for the selected doctor. Instead, the system 20 will instruct the patient to check back within the set time period. However, the patient is still able to enter his/her email 38 and telephone 40 information to receive automated updates via email or sms text messaging prior to the scheduled appointment time.

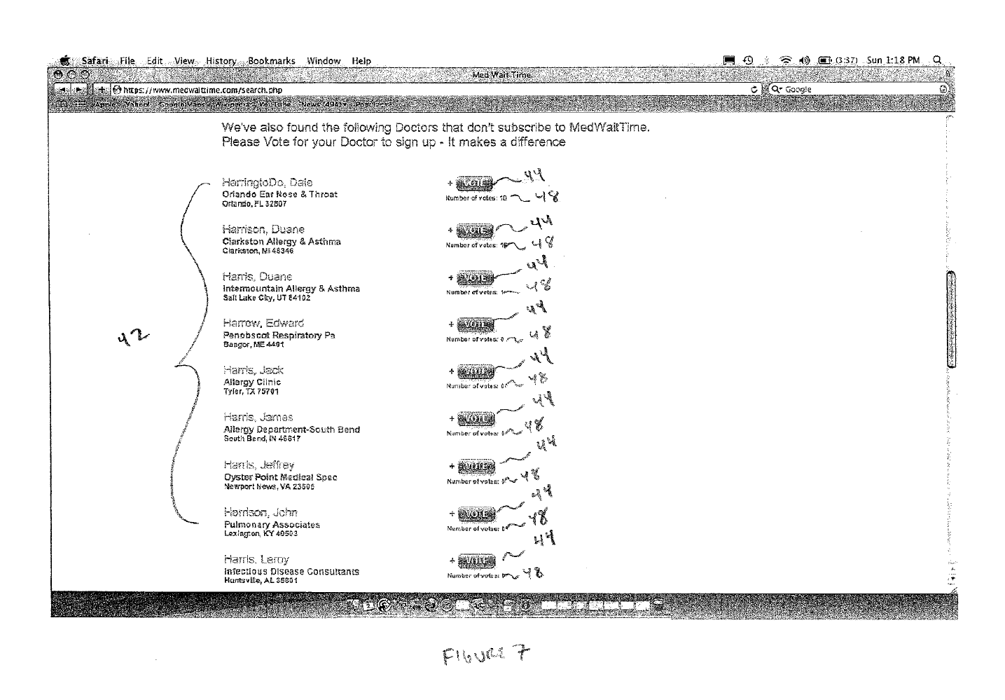

In addition to retrieving the subscribing doctors 32, the system 20 is also configured to retrieve non-subscribing doctors. FIG. 7 is a list of non-subscribing doctors which appear beneath the subscribing doctors 32. If the patient's doctor is a non-subscribing doctor 42, the patient may “vote” for his/her doctor to sign up to the system 20 by selecting the “Vote” button 44. As shown in FIG. 8, the patient may enter in his/her contact information 46 should the patient wish to receive notification once his/her doctor becomes a subscribing doctor 32. The number of votes 48 are counted and displayed for each non-subscribing doctor.

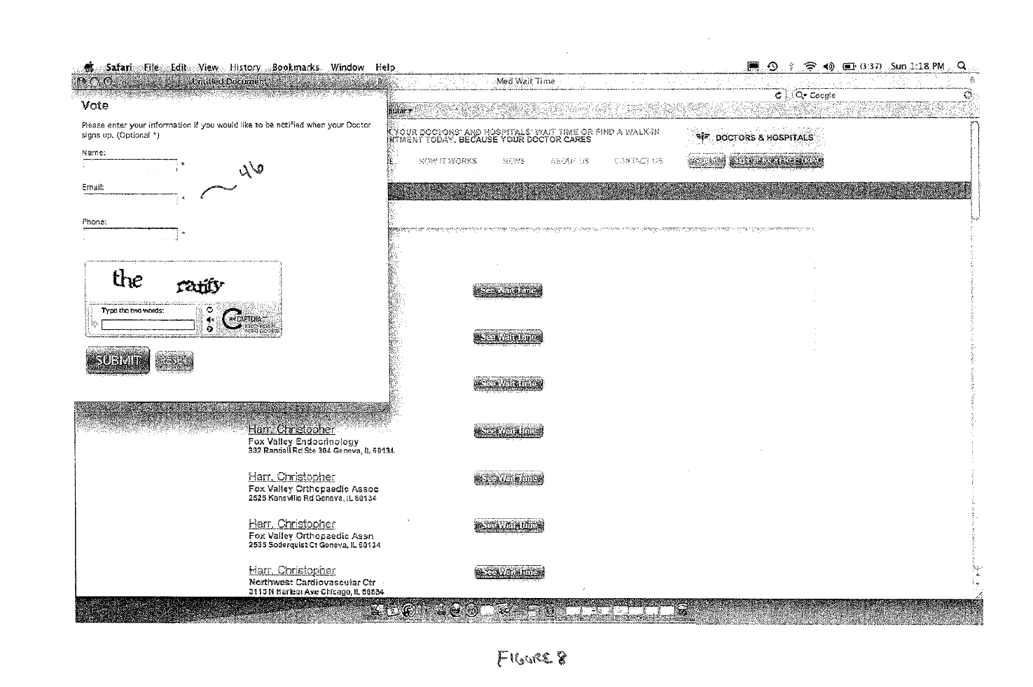

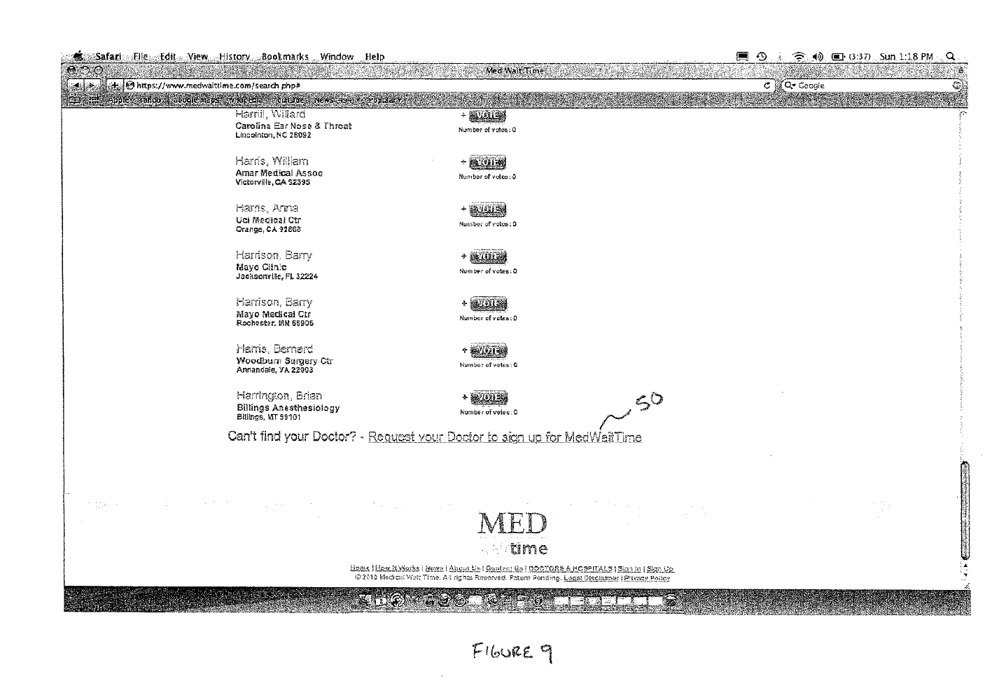

If the patient's doctor does is not listed as a non-subscribing doctor 42, the patient may enter the doctor's contact information 50 as shown in FIG. 9. The patient may enter in the contact information 46 of the doctor and his/her own information if the patient would like to be notified if the doctor subscribes to the system 20.

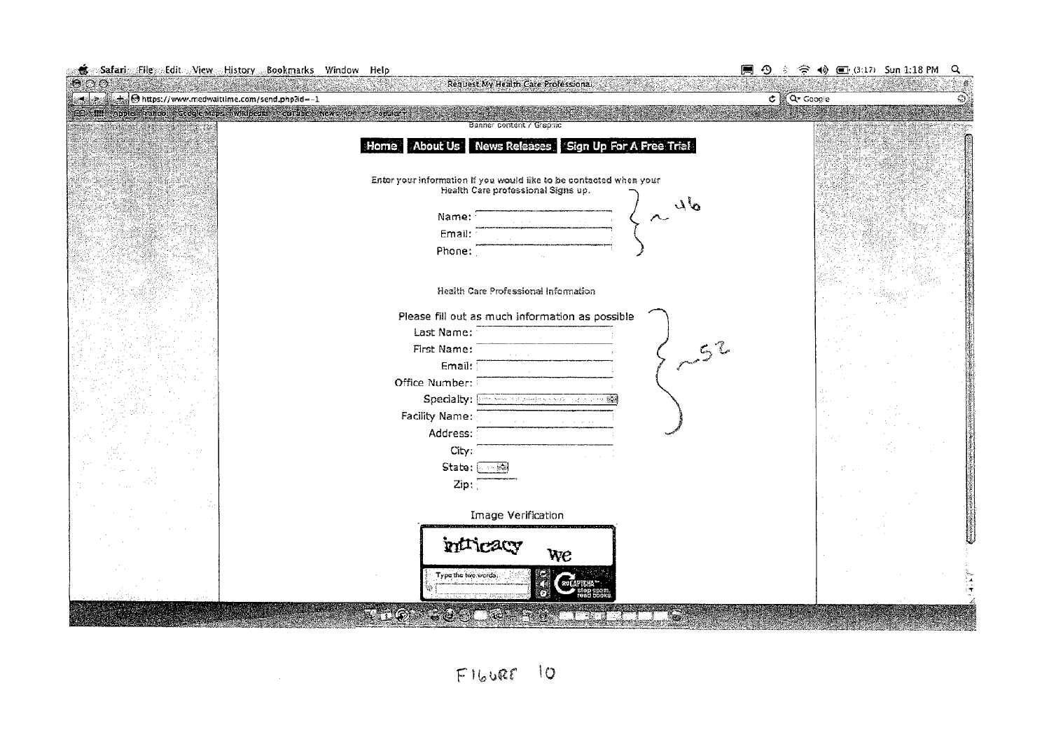

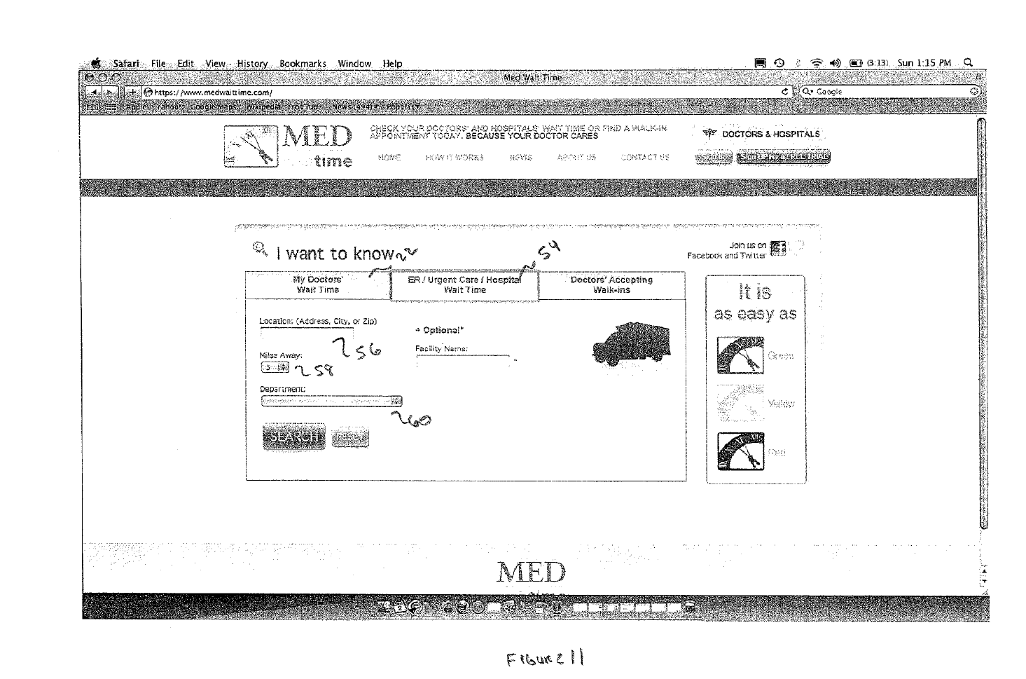

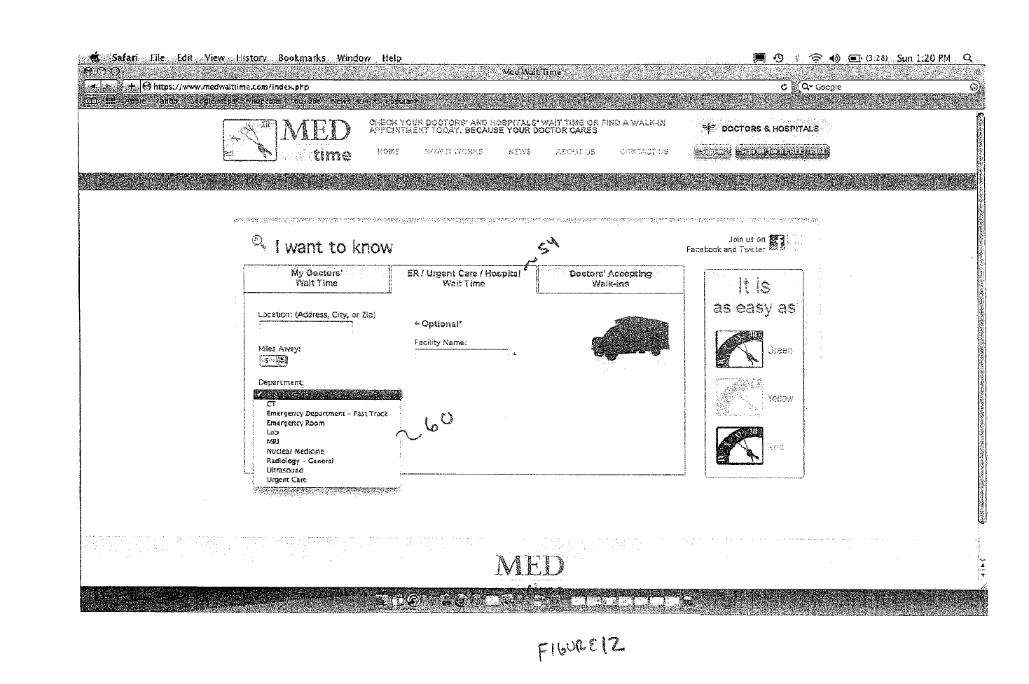

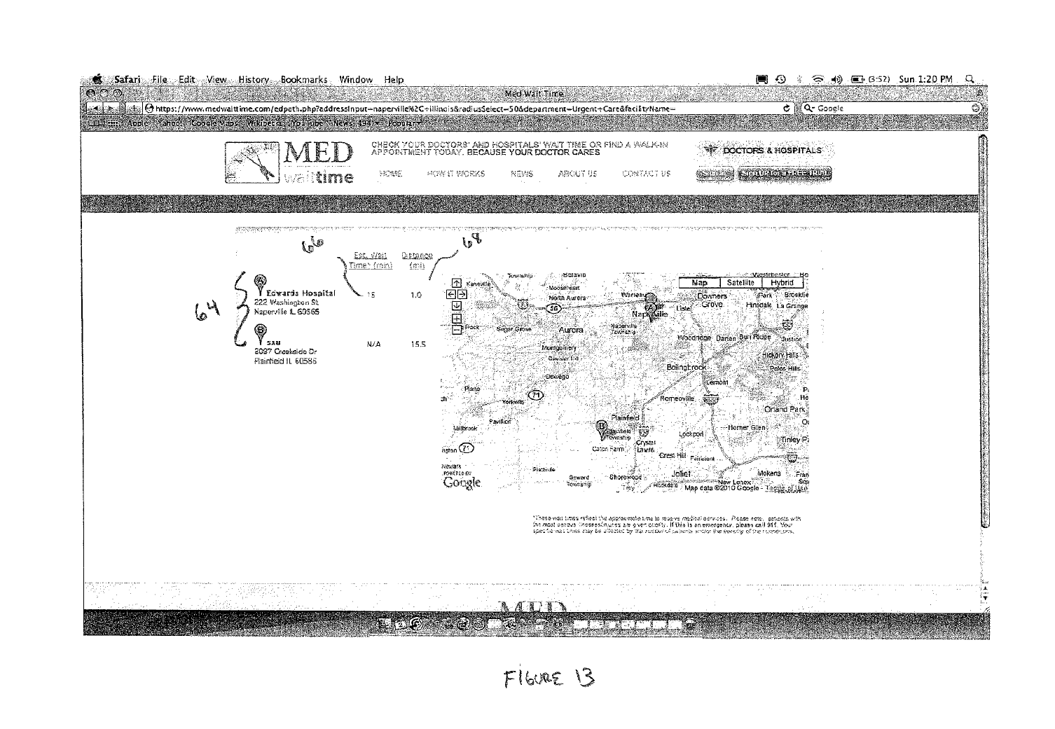

As shown in FIG. 11, wait times for find emergency rooms, urgent cares, or hospital department may also be retrieved under the hospital department wait time section 54. The search location, which is typically the patient's location, is entered in the field 56. The input may be address, city, or zip code. The radius 58 from the search location 56 is entered and the specific department 60 may be selected, as further shown in FIG. 12. The patient may also enter the facility name 62, if desired. The system 20 will retrieve the selected department 64 within the selected radius 58 of the inputted search location 56, as shown in FIG. 13. The system will also provide the current wait time 66 and distance 68 to the entered search location 56 for each facility. As shown in FIG. 14, the system 20 will also display additional information 20 submitted by the facility, such as that facility's web site and any additional message, such as accepted insurance policies. The system 20 will also allow the patient to get directions 72 to the selected facility from the search location 56.

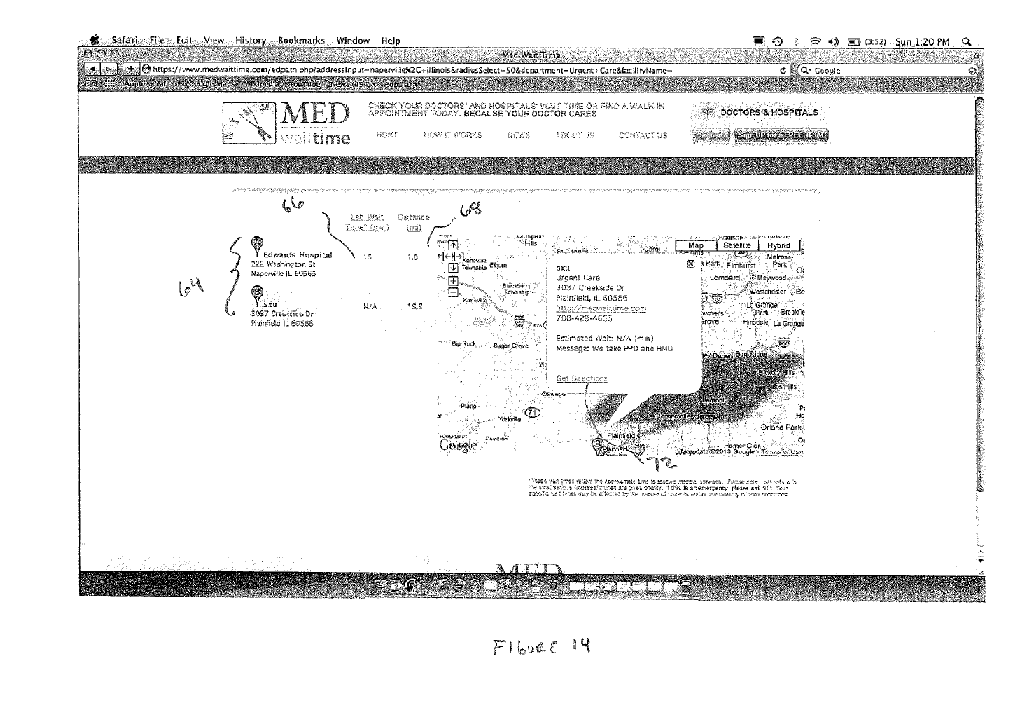

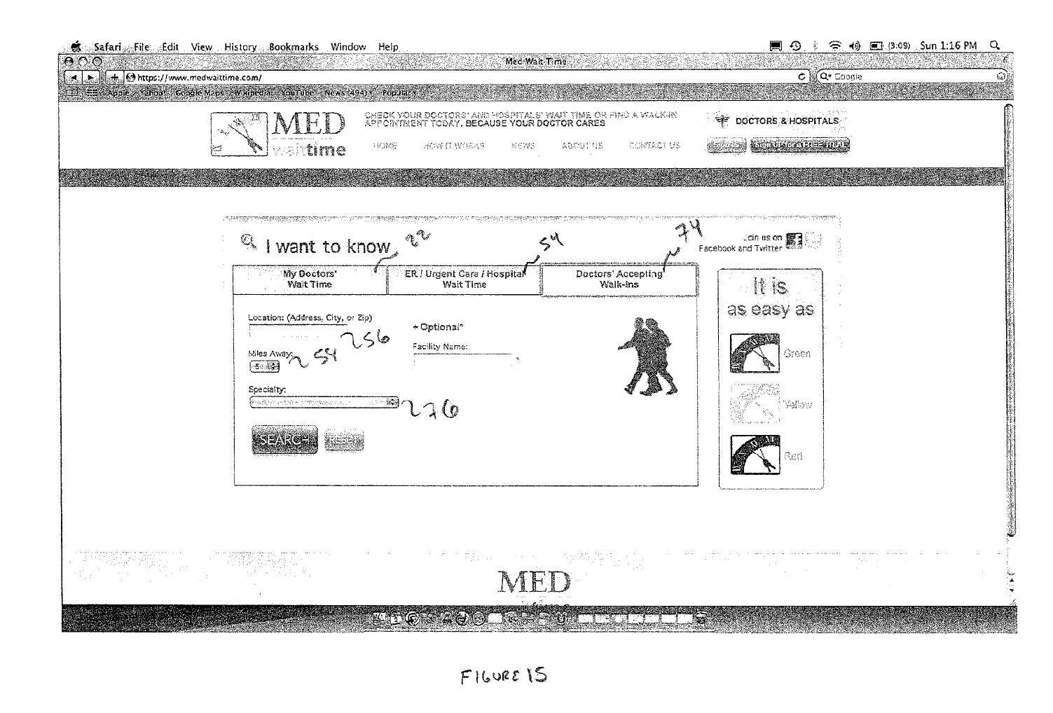

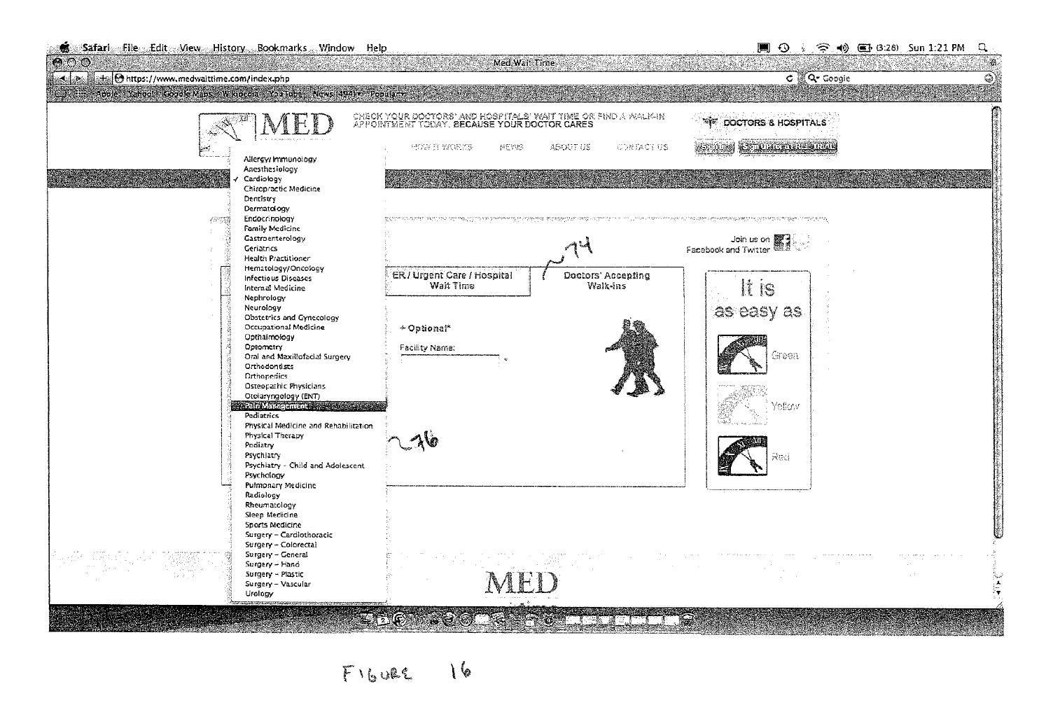

As shown in FIG. 15, the system 20 also permits a patient to search for doctors' accepting walk-in appointments in section 74. The patient enters the location 56, selects a radius 58 from that search location 56 and a specialty department 76, a listing of which can be seen in FIG. 16. The patient may also be able to search by appointment availability for a particular day or time frame. The system 20 returns a listing of results 78 of doctors accepting walk-in appointments along with the distance 80 from the search location 56. Additional information 70 may be displayed for the selected doctor, including the doctor's website 82, custom message 84, and driving directions 86.

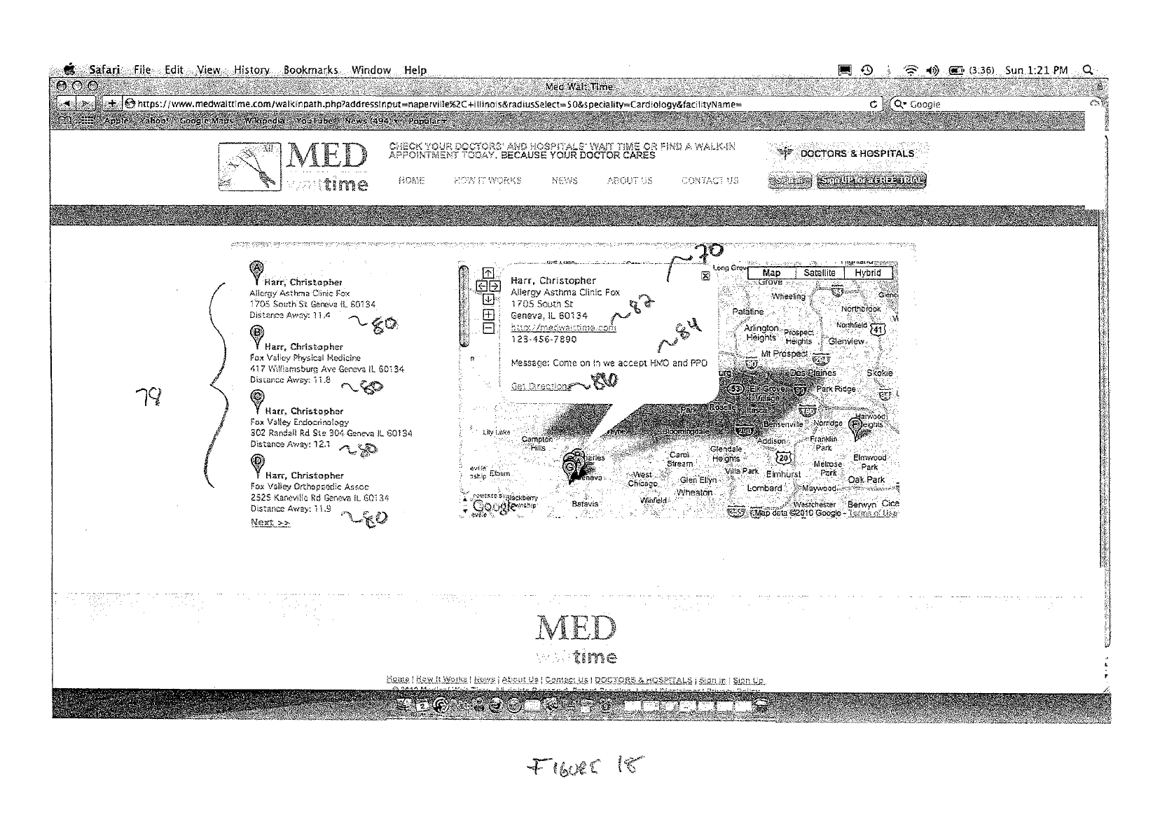

The user interface 87 of the system 20 permits doctors or hospitals to enter and update wait time information. As shown in FIG. 20, the doctor/hospital/status updater (each referred to as a “user”) inputs his/her log in information in the field 88 to access the system 20. The user will be able to select an initial location 90 and the type of user (e.g. Doctor or ER/Urgent Care/Hospital) during the account sign-up process.

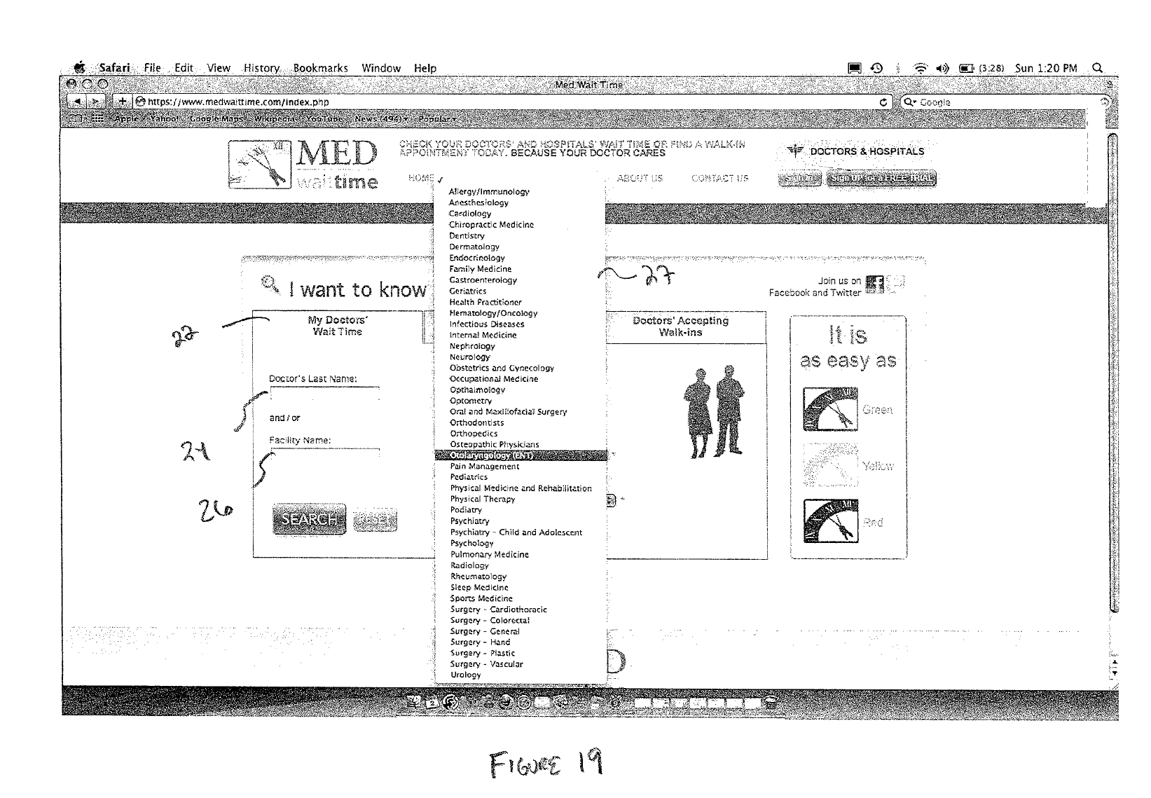

As shown in FIG. 21, the system 20 will provide a list of locations 90 which the user is currently subscribed to. Each location 90 will list the current status 92, time to arrive after the scheduled appointment 94, the custom message 96, whether the location is accepting walk-ins 102, the message for walk-ins 98, and whether a status updater is assigned to that location 100. The user will be able to update any of these fields and will be able to remove the location 104, add/remove a status updater 106, and update the status 108.

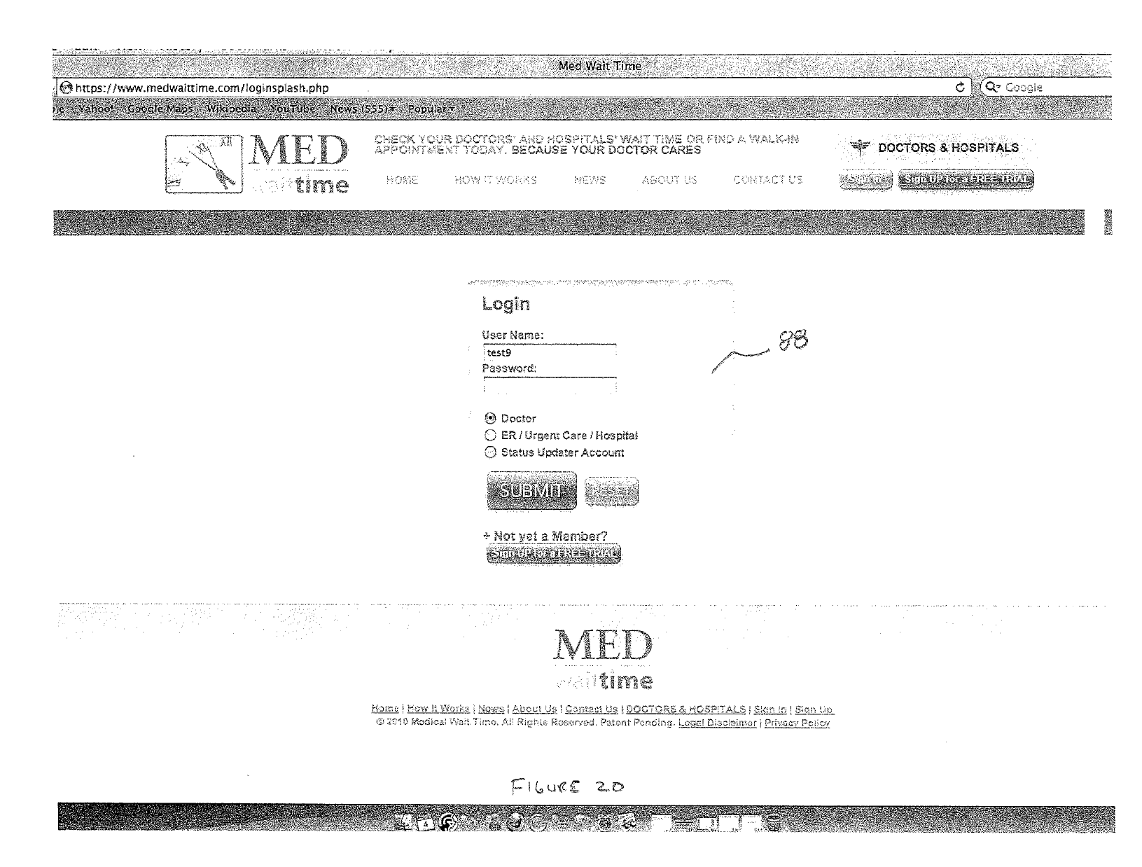

If the user selects the update the status 108, the system 20 will return a page similar to that shown in FIG. 22. The user will be able to update the current status 92 to green, yellow, red, or N/A; update the time to show up after the scheduled appointment 94, the custom message 96, whether the location is accepting walk-ins 102, the message for walk-ins 98, the office number 110, and the location's website 112. This information will be displayed to a patient when this particular location is selected for the doctor, hospital, or urgent care center. It can be appreciated that not all three of the types of users will have all the same functionality and is application dependent.

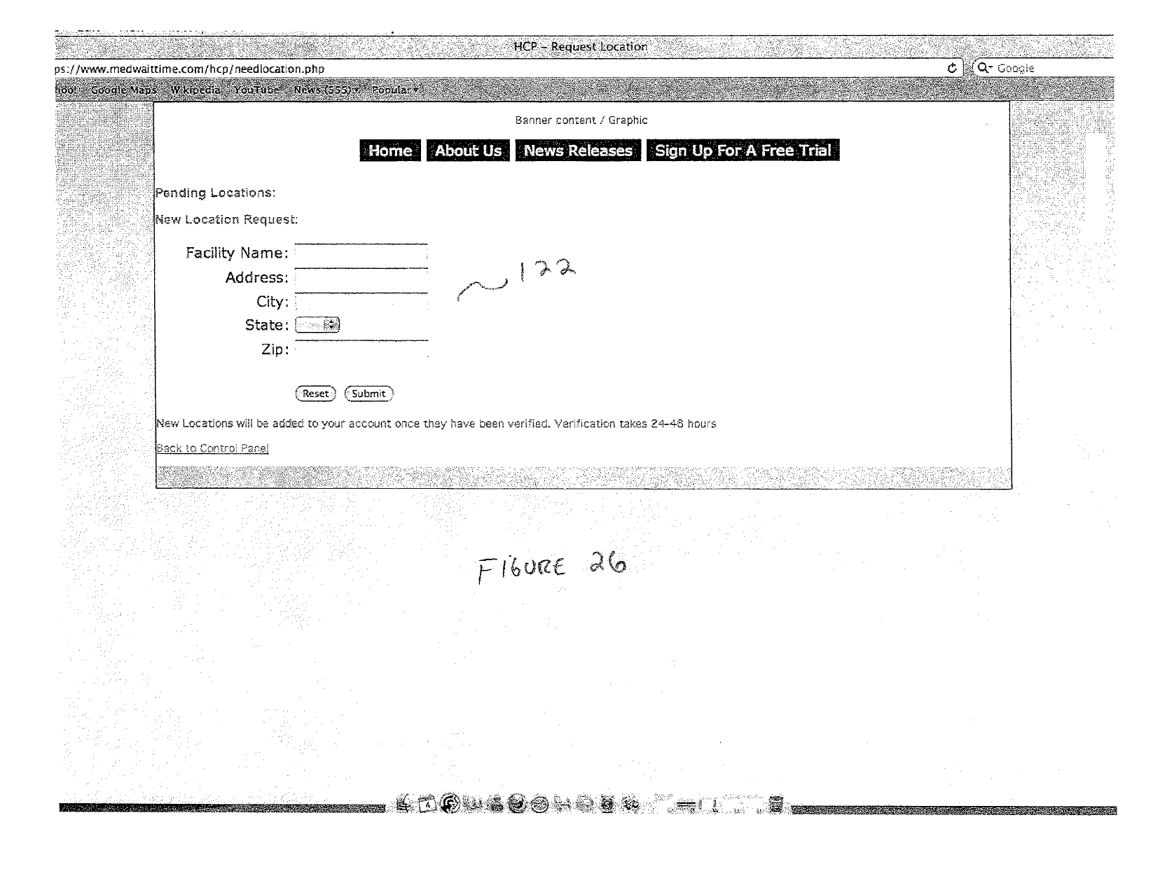

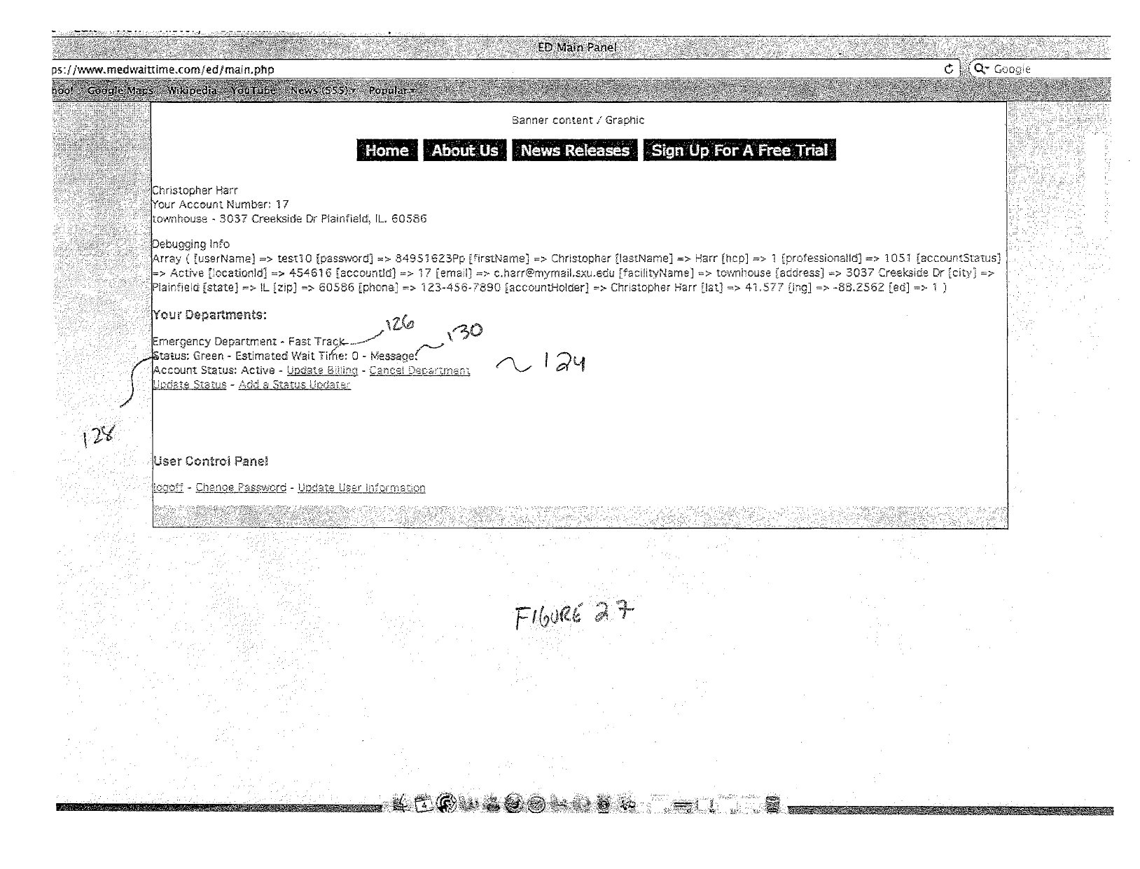

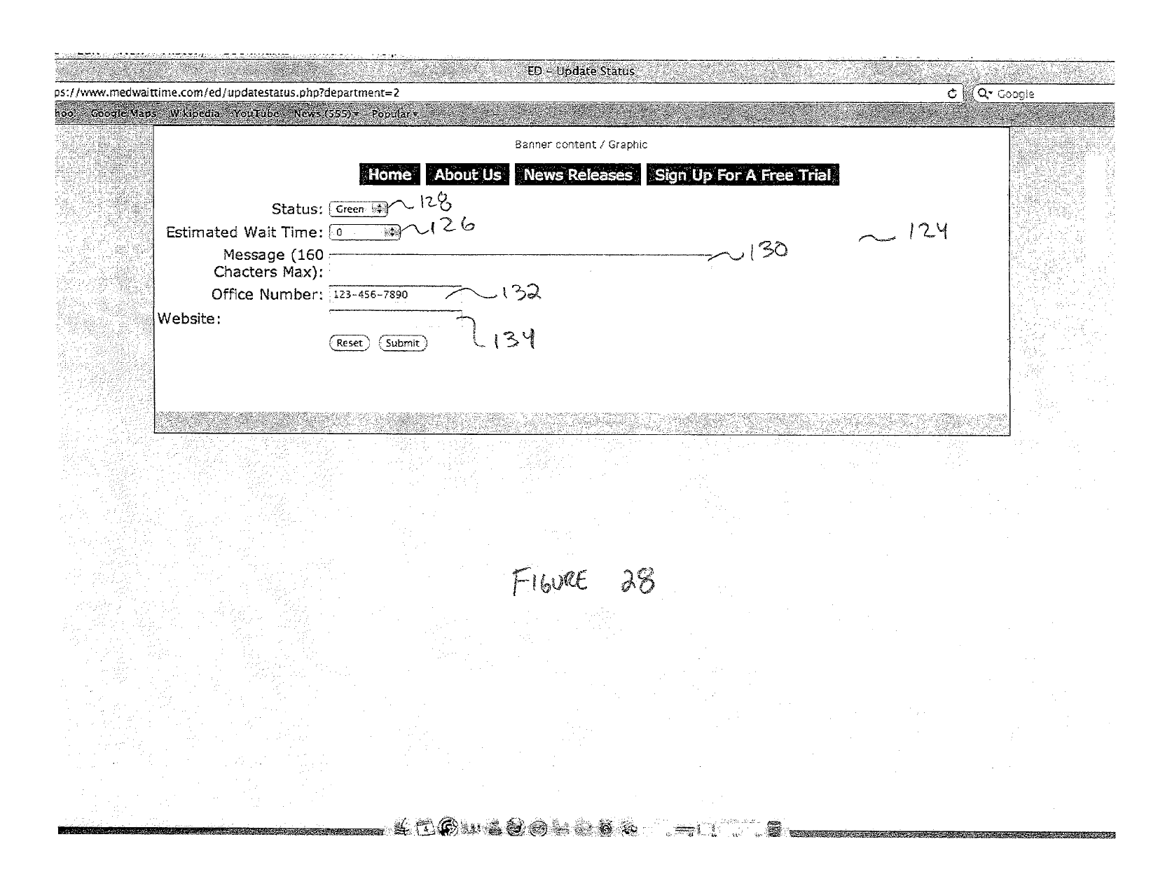

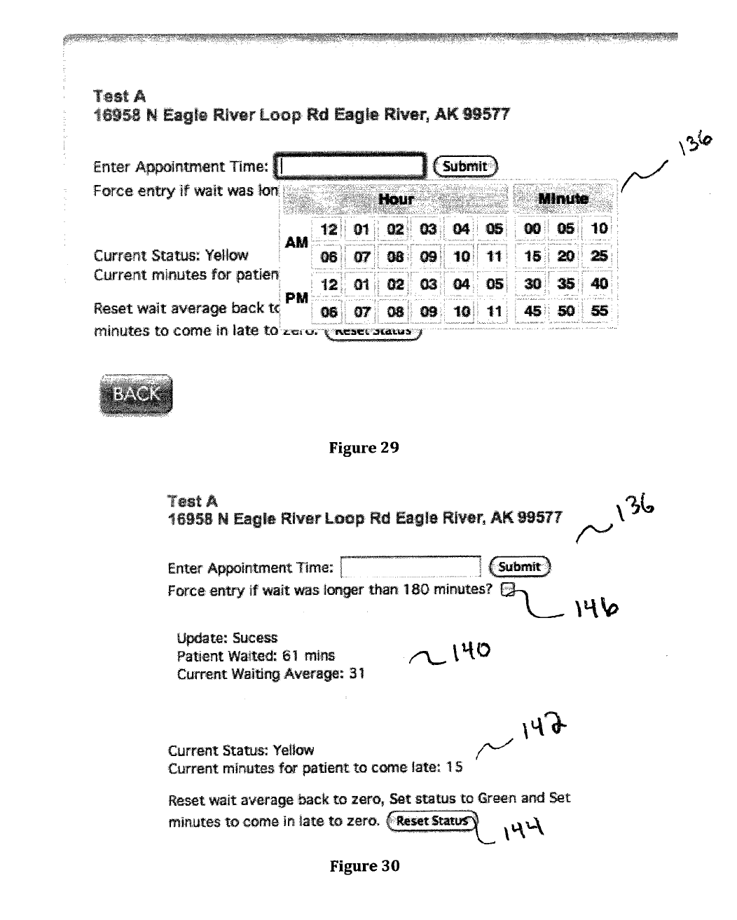

In another embodiment, the user may elect to use the wait time calculator 136, as shown in FIG. 29. The wait time calculator 136 calculates the wait time by calculating the difference between the current time and the appointment time. The wait time calculator 136 prompts the user to enter the patient's appointment time 138. The wait time calculator 136 will then calculate the current wait time by subtracting the current time from the appointment time 138 and provide a status 140 to the user as shown in FIG. 30. This process is then repeated for subsequent appointments.

The current wait time will be the average of the difference between current time and the appointment time. The current wait time will be assigned a color (e.g. green, yellow, red) based on predetermined values. For example, the color green will be assigned to wait times under 30 minutes, the color yellow if the wait time is between 31-60 minutes, and red for wait times over 60 minutes. The number of minutes that a patient will be allowed to come in late will be calculated by dividing the wait time by a predetermined reduction factor. The reduction factor and wait time color ranges can be modified by the user. The status color and number of minutes to allow a patient to come late will be provided to the user in a display 142. In addition, a reset button 144 is provided to allow the user to reset the current wait time if an error is made or for any other reason (e.g. different doctor or if doctor makes up time). Finally, the wait time calculator 136 has a fail safe system where if the difference between the appointment time and current time is over a certain amount of minutes (for example 180 minutes), the wait time calculator 136 will prompt the user to confirm that the inputted appointment time is correct prior to calculating the wait time. There is also an override feature 146 if the user is aware that the difference between the appointment time and current time is greater than a predetermined amount of time.

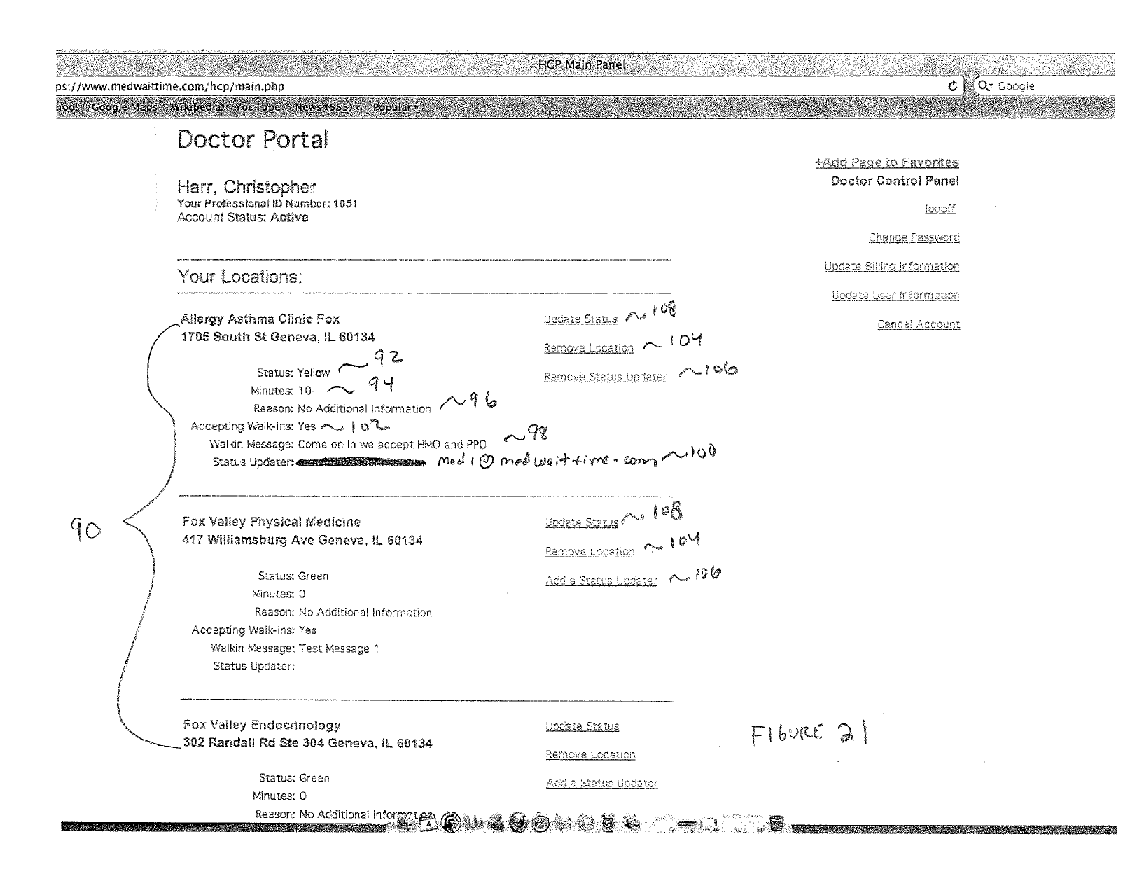

If the user selects to add as status updater 106, as shown in FIG. 21, he/she may do so. The status updater 106 is another account that may be created by the user who can also control any location designated by the user. Multiple locations may be assigned to a single status updater 106 and more than one status updater 106 may be assigned to a single location. To add a status updater 106, the system 20 will request that the user enter an email address 114 that will be connected to that status updater 106 as shown in FIG. 23.

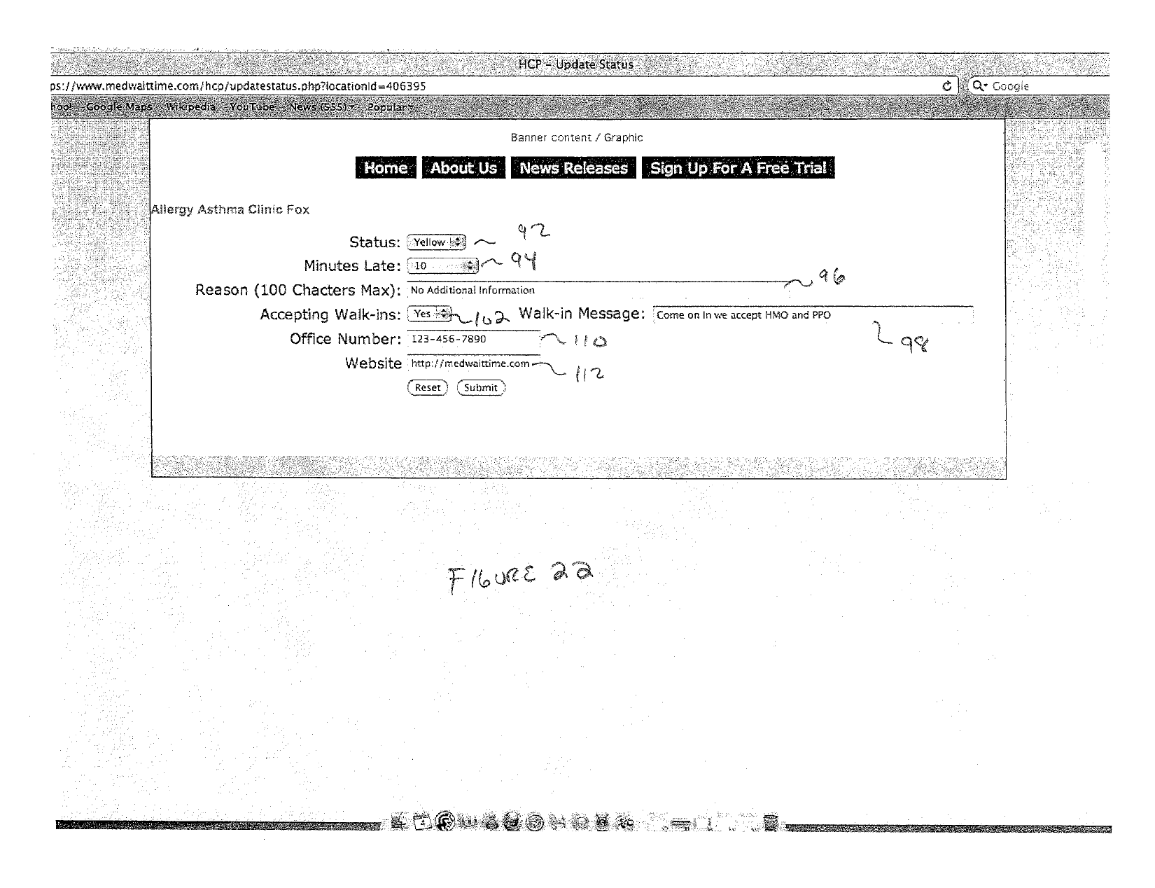

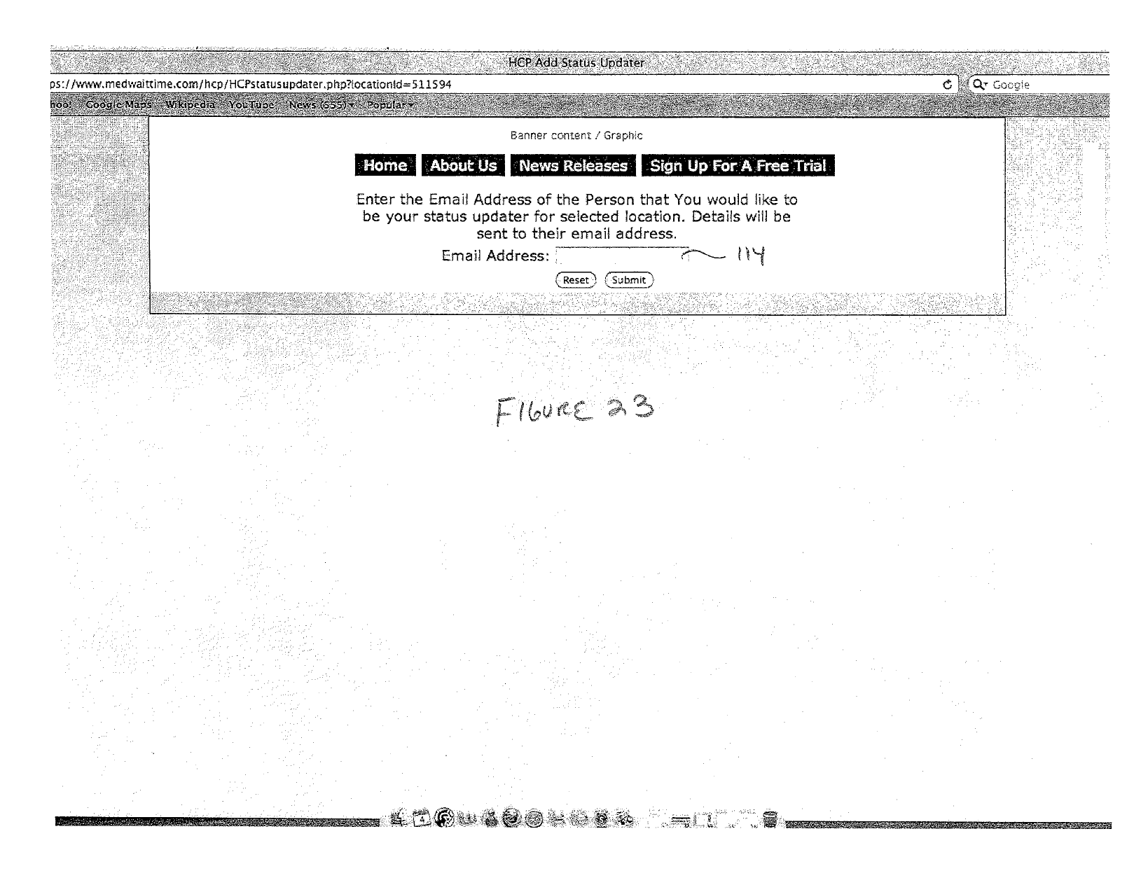

If the user wishes to add another location, such as another office for a doctor, or another urgent care location for an urgent care, he/she may do so by selecting the “Add a Location” link 116 at the bottom of the Doctor Portal, as shown in FIG. 24. The system will return a form 118, as shown in FIG. 25, requesting the user to search the database for existing locations. Because more than one user may be assigned to a single location, the desired location may already be inputted into the database. If not, the user may select the link “Location Not Listed?” 17 on the bottom of the page to manually enter the address of the new location.

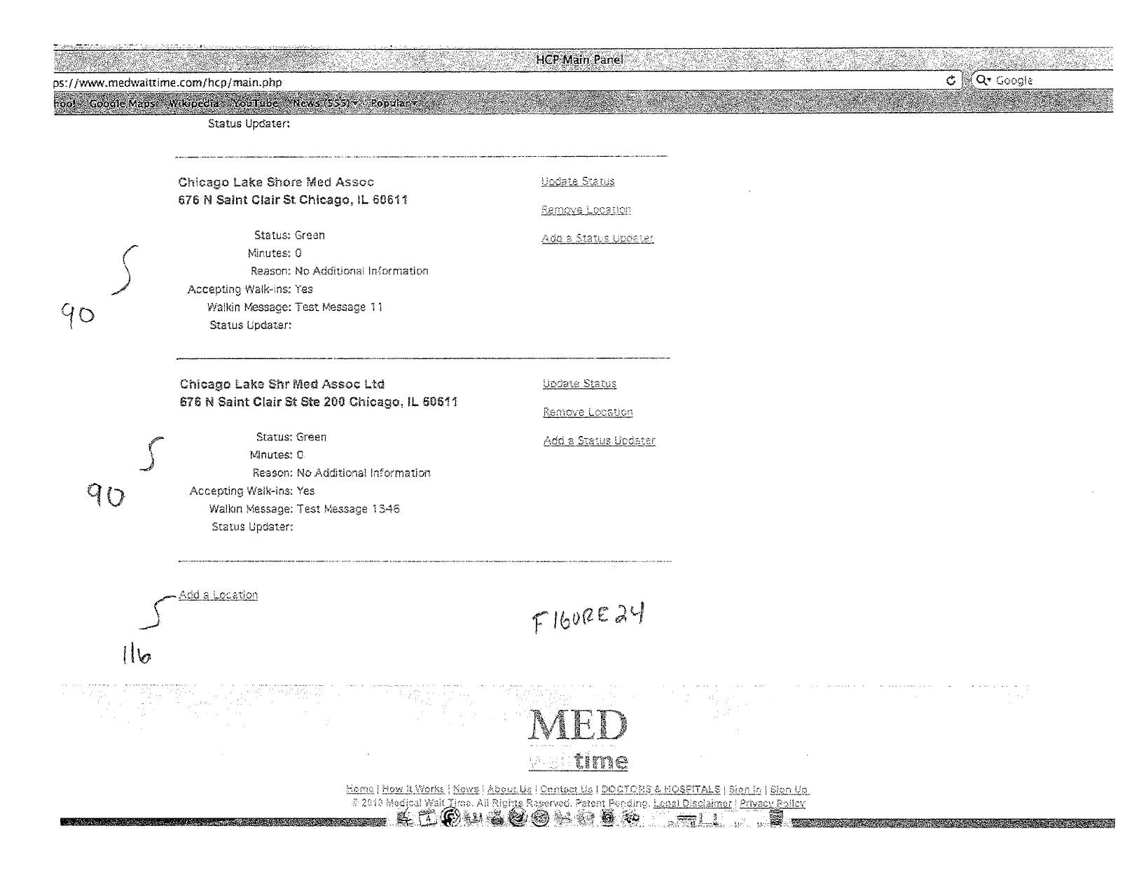

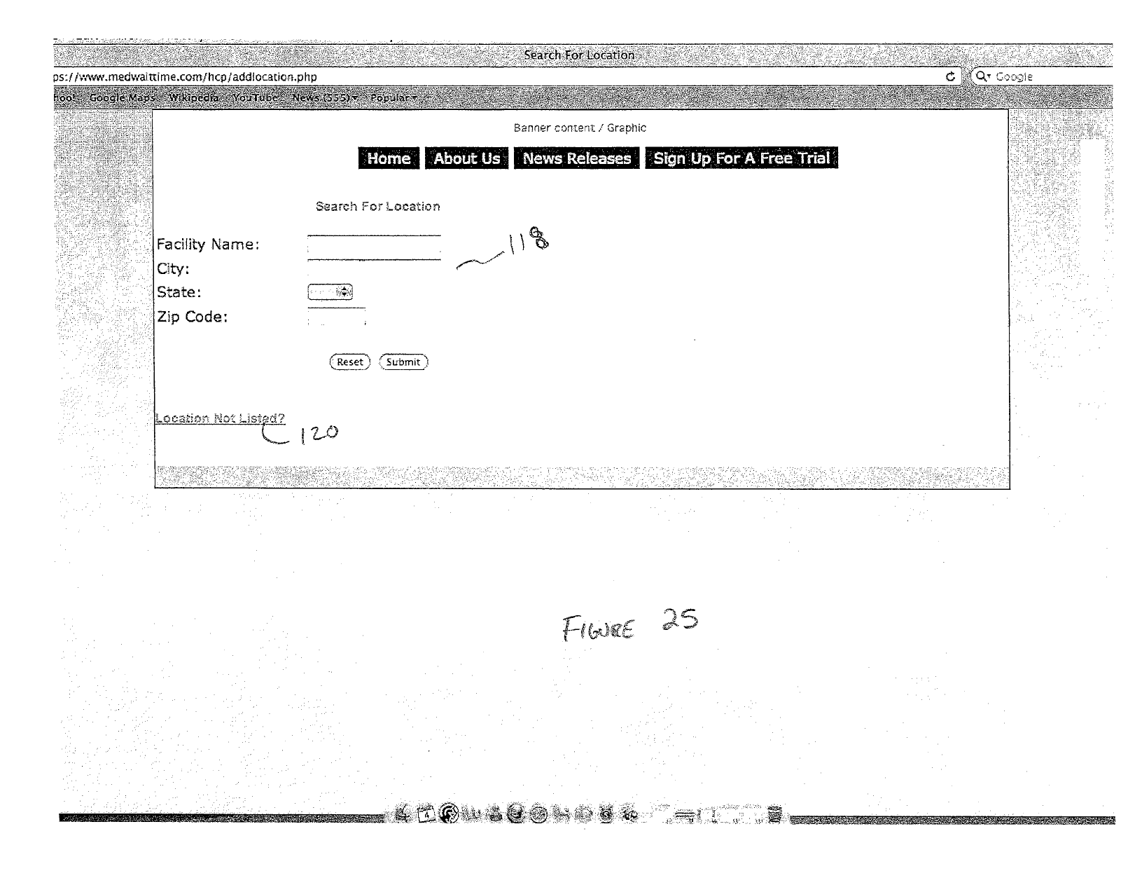

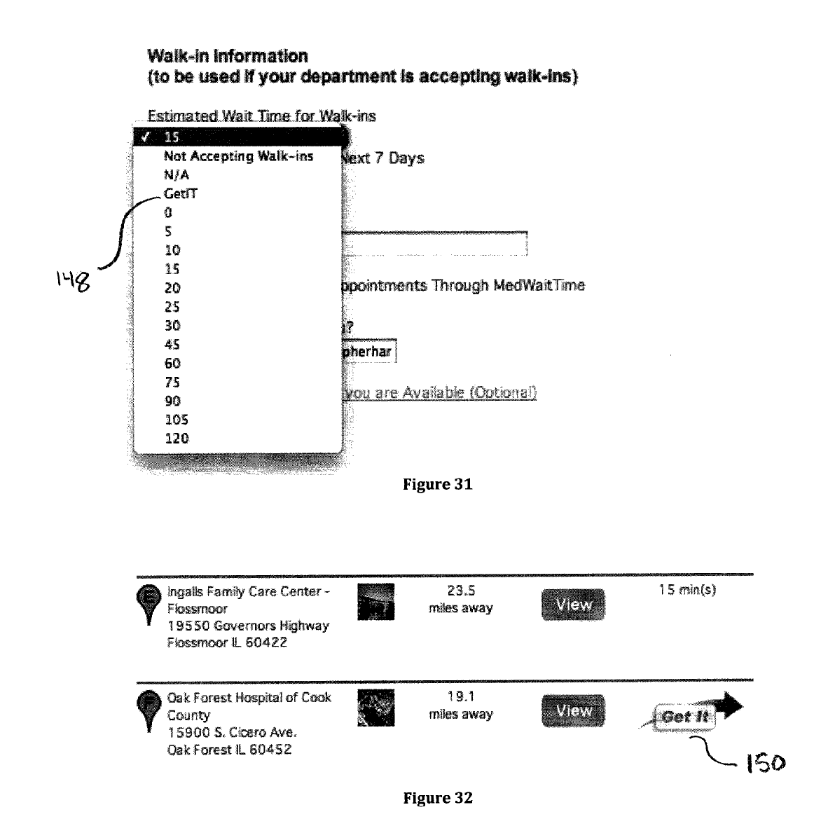

FIG. 27 is the department listing for a user who logs in as an emergency room (one type of health care facility). The ER location 124 displays the estimate wait times 126, status color 128, and any message 130. FIG. 28 is the page which the user may add change the status 128, estimated wait time 126, and message 130, and add an office number 132 and website 134. Similar to the functionality with the doctor locations 90, the user may enter in additional ER locations, add a status updater, and add a location. The same is holds true for other hospital departments users, such as cardiology, and the urgent care users. It can be appreciated that the wait time 126 may be displayed independent of the status color 128 or message 130. In addition, the wait time may be automated whereby the system 20 will pull the wait time information, or information from which it can derive an estimate wait time, from a third party source, including the client's patient management system. The same holds for the doctor wait times. In any event, the automated wait time can still changed manually via the process described above. As shown in FIG. 31, the wait time options include: the wait time (in minutes); N/A; and “Getlt” 148.

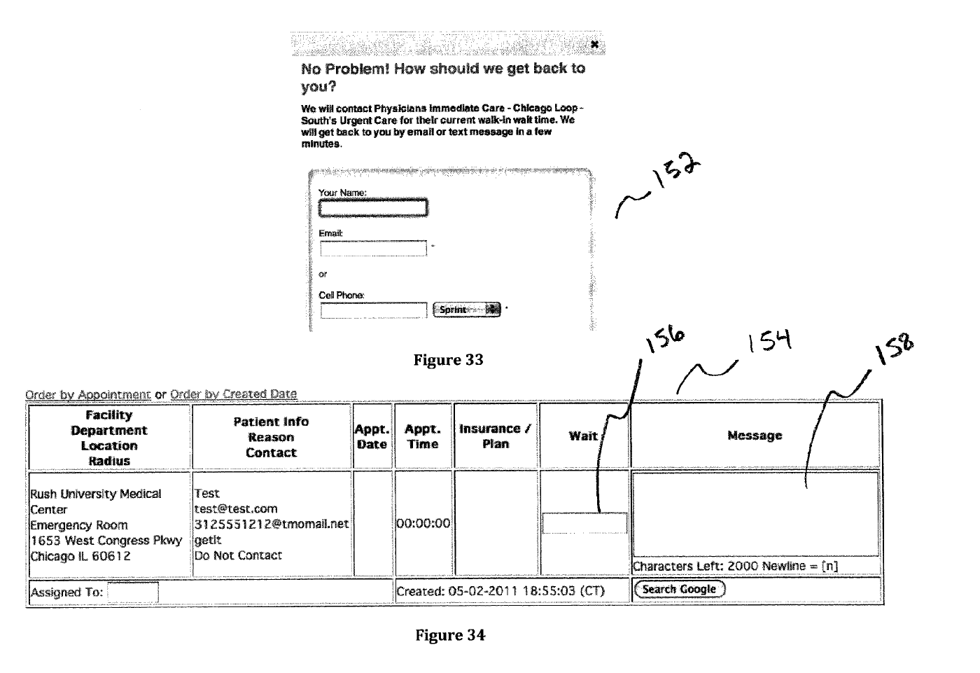

If the N/A option is selected, the wait time for that facility will show up as N/A. If the “Getlt” option 148 is selected, a “Getlt” icon 150 will appear for that facility when viewed by a patient, as shown in FIG. 32. By clicking on the “Getlt” icon 150, the patient will be prompted to input their contact information 152, as shown in FIG. 33, and the system will generate a manual inquiry 154, as shown in FIG. 34. The wait time for that particular facility will be manually retrieved and will be entered in the wait time field 156. Additional information may also be entered into the comments section 158. The system 20 will then send the wait time and comments information to the patient through the means specified by the patient. The same process may be done for a patient seeking a doctor's appointment. In this scenario, a patient may request an appointment for a particular doctor or a specialty within a specified amount of time. This information will either be sent directly to that doctor to enable the doctor to schedule an appointment with the patient or will generate a manual inquiry similar to that for the wait times for the health care facility. Further, the patient may use the “SmartSearch” feature whereby the system will calculate the wait time for the patient based on the wait time for a particular facility plus the commuting time it will take the patient to arrive at that facility. The commuting time may be based on the entered location of the patient (zip code , city, address) and the location of the facility. Real-time traffic information may also be considered in determining the commuting time.

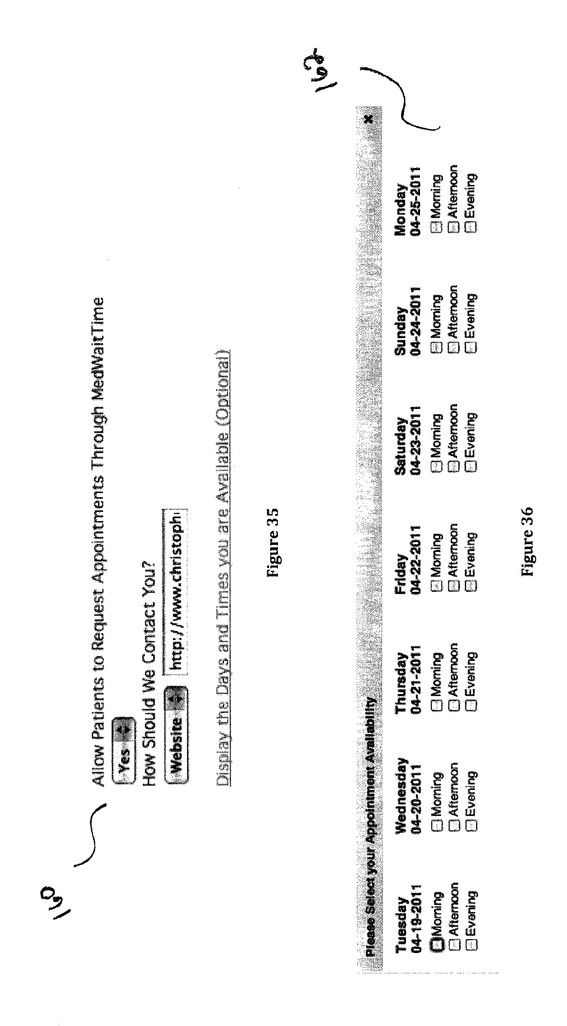

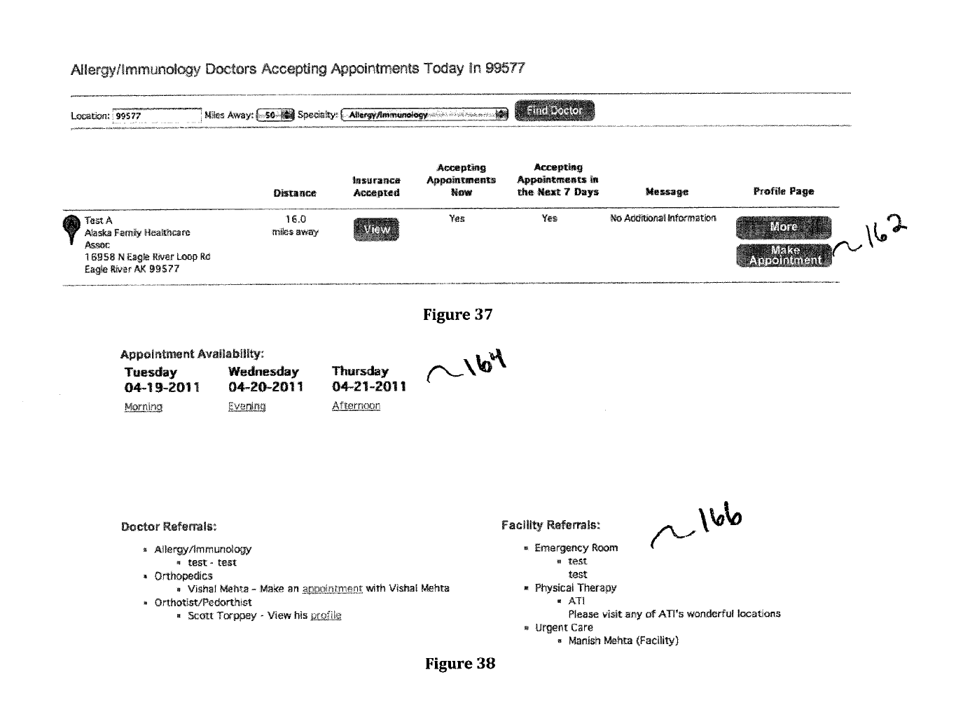

In an alternate embodiment, the user may display specific appointment times through the system and allow the patient to request an appointment for a particular date. As shown in FIG. 35, the user may enable patients through an appointment feature 160 to request a specific appointment. The user may also be able to display the appointment availability 162 over a set period of time, as shown in FIG. 36. The patient, when searching for a particular specialty or a particular doctor, will be able to request an appointment generally 164 or for a specific time frame (e.g. hours or periods of day) 164 as shown in FIG. 37. This information can be displayed on a particular doctor's profile page or in a listing of doctors accepting appointments. The same feature is available for any other services that can accept appointments.

Also included on a doctor's profile page may be a his/her referrals via a referral listing 166, as shown in FIG. 38. The referral listing 166 lists the trusted referrals of a doctor. Referrals may be any other health care professional or facility. Patients may be able to search for or sort through health care professionals or facilities based on the number of other health care professionals or facilities have listed that particular health care professional or facility as a referral. The number of referrals offers a sense of credibility for that particular health care provider (which includes both health care professionals and health care facilities). Health care providers may request another health care provider to become a referral.

It can also be appreciated that an advertising component may be part of the system 20, where a specific advertisement of a user will be displayed if a patient enters in a particular location, such as an address, city, state, and/or zip code. The database will contain a list of advertisements that are associated with each location and upon entry of that location by the patient, the system 20 will retrieve the associated advertisement and display it along with the list of locations.

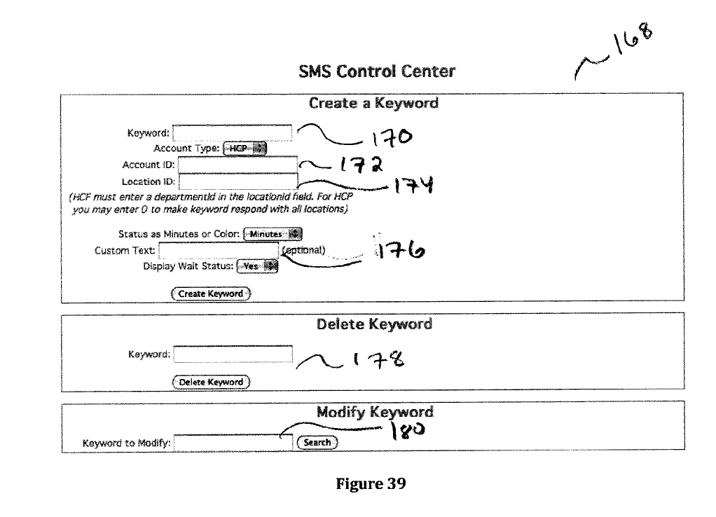

In another embodiment, as shown in FIG. 39, the patient may be able to request the wait time for his/her doctor or health care facility be sending a SMS text to a predetermined phone number. The SMS text will be in the form of a unique code that will be specific to the doctor or facility. The system 20 will receive the unique code, may send it to the server 16 to ascertain the current wait time in the database 18. The server 16 may send the wait time for that unique identifier to the cell phone number that sent the unique code. The phone number will be stored in the database 17 along with the particular doctor or health care facility for which the wait time was requested and the time stamp. The unique code, or keyword, can be created by the user using the SMS control panel 168 as shown in FIG. 39.

The SMS control panel 168 enables the user to create a unique keyword that patients can SMS to get the wait time for a particular doctor or health care facility. A proposed keyword is inputted in the keyword field 170 and the Location ID 172 and Account ID 174 for the desired doctor or health care facility may be inputted. The information returned in response to a SMS text request to an unique keyword can either be in minutes or color and a custom text 176 can be provided. The unique keyword can be deleted 178 or the modify keyword field 180 allows the specifics for a particular keyword to be changed.

It can be appreciated that a group word plus keyword system may also be used. When a user texts a group word+keywords the message is sent to another server by the system 20. The other server decides if the group word that was sent is valid for the system 20. If the group word is valid it calls their API to fetch a page from the system 20. The other server or the system 20 logs the patients cell phone number and what group they belong to. Subscribing to each group word calls a page from the system 20 with different variables.

The system 20 parses the variables that are sent from the other server, this begins several processes system 20. First the cell phone number, group word, keyword and time the request came is logged to our mysql database. Second the system 20 assumes this is a new opt-in request and attempt to remove the cell phone number from our opt-out database. Third the look up process begins to see if the data sent from the other server is valid. If the data is valid information requested is pulled from the database 18. A log is created to bill the user in the system's 20 database 18. If the information is invalid, system 20 still log's the information as a hit but in the log “error” is appended to the keyword. An error message is generated which is sent back to the other server.

To opt-out simply text “stop+groupword” to a selected number. The other server removes the cell phone number from its groups and sends a request to the system 20 to process the request. Each request calls the same page on system 20 with the same variables. The system's 20 server 16 logs the cell phone number to the opt-out portion of the database 18 to remove any further communication to the patient's cell phone.

The database 18 of the system 20 stores all the cellular phone numbers for each keyword. This enables users to send periodic messages to all of the numbers that sent a SMS message to a particular keyword. The manner in which this is done is similar to the custom message feature 84 discussed above.

It is also contemplated that the system 20 will have an appointment reminder system, such that the user will input the phone number or email address of a patient and the system 20 will remind that patient of that appointment on the day of the scheduled appointment via an email or text message. Along with the reminder, the system 20 will also send the current wait time, color status, and any additional information inputted into the system by the user or status updater.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure.

Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

1. A method for notifying a user about the wait information, the method comprising:
storing the wait information for a particular service provider in the database;
receiving a request for the wait information for the particular service provider;
retrieving the wait information for the particular service provider from the database; and
providing the wait information for the particular service provider to the user.

2. The method of claim 1 wherein providing the wait information comprises providing the minutes the user is allowed to come after a scheduled appointment.

3. The method of claim 1 wherein providing the wait information comprises providing a color status of the wait information.

4. The method of claim 1 wherein providing the wait information comprises providing the number of minutes the service provider is running behind schedule.

5. The method of claim 1 wherein receiving a request for the wait information comprises storing an email.

6. The method of claim 1 wherein receiving a request for the wait information comprises receiving an appointment time for the user.

7. The method of claim 1 wherein sending the wait information comprises transmitting the wait information via email.

8. The method of claim 1 wherein sending the wait information comprises transmitting the wait information via SMS messaging.

9. A method for providing a user wait information, the method comprising:
storing the wait information for a particular service provider in the database;
receiving an appointment time for a user;
comparing the appointment time with the current time;
retrieving the wait information for the particular service provider from the database if the difference between the appointment time and current time is less than a first set time;
sending the wait information for the particular service provider to the user at a first predetermined time prior to the appointment time.

10. A system for providing the wait information to a user, the system comprising:
at least one server in communication with a network;
a database in communication with the server having stored herein data relating to the wait information for at least one service provider, the data comprising a unique identification for the at least one service provider and the wait information including the wait time for the at least one service provider;
the server configured to receive an input signal across the network requesting the wait information for the at least one service provider;
the server configured to retrieve the wait information for the at least one service provider from the database; and
the server configured to transmit an output signal across the network in response to the input signal requesting the wait information for the at least one service provider, wherein the output signal includes the wait information for the at least one service provider.

11. The system of claim 10 wherein the wait information further comprises a message stored in the database.

12. A system for providing the wait information to a user, the system comprising:
at least one server in communication with a network;
a database in communication with the server having stored herein data relating to the wait information for at least one service provider, the data comprising a unique identification for the at least one service provider and the wait information including the wait time for the at least one service provider;
the server configured to receive an input signal across the network requesting the wait information for the at least one service provider, wherein the input signal comprises an appointment time;
a processor in communication with the server, the processor configured to compare the appointment time to the current time to determine a time difference;
the server configured to retrieve the wait information for the at least one service provider from the database if the time difference is less than a first set time; and
the server configured to transmit an output signal across the network in response to the input signal requesting the wait information for the at least one service provider, wherein the output signal includes the wait information for the at least one service provider.

13. The system of claim 12 wherein the server is configured to not retrieve the wait information if the time difference is greater than the first set time.

14. The system of claim 12 wherein the wait information is manually inputted into the database.

15. The system of claim 12 wherein the output signal is transmitted via sms message.

16. The system of claim 12 wherein the output signal is transmitted via email.

17. The system of claim 12 wherein the server is configured to transmit a second output signal with the wait information for at least one service provider after a second set time.

18. The system of claim 12 wherein the database receives the wait information from a patient management system.

19. The system of claim 18 wherein the patient management system calculates the wait time for the at least one service provider.

20. There system of claim 19 wherein the processor is configured to calculate time the user is allowed to arrive prior to the appointment time.
